(19) United States
(12) Patent Application Publication
(10) Pub. No.: US 2004/0005926 A1
(43) Pub. Date: Jan. 8, 2004

(54) Interactive game

(76) Inventor: Greg W LeFroy, Toronto (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 10/362,101

(22) PCT Filed: Aug. 20, 2001
(86) PCT No.: PCT/CA01/01171

(51) Int. Cl. G06F 19/00; G06F 17/00

(52) U.S. Cl. 463/42

(57) ABSTRACT

There is provided a method and system for playing a multi-player interactive game in conjunction with a single event, such as a major league baseball game. The event is divided into a plurality of sub-events, with a plurality of possible outcomes for each sub-event. Prior to the event, potential quantitative outcomes for each sub-event are assigned. Numeric weights, used to calculate scores, are assigned to each of the potential outcomes. Players attempt to predict actual outcomes from a list of possible outcomes for each sub-event. Players may access relevant statistics to help make their predictions. During the event player scores are calculated for each player by assigning points, based on the numeric weights, for each of the player's predicted outcomes that match actual outcomes, Player scores are regularly updated during the event and displayed. Once the event finishes, final scores are calculated for each player and prizes are awarded. The game may be implemented in many forms, including on one or more computers networked together, via the Internet or on a personal digital assistant with wireless communication capability.

### FIELD OF THE INVENTION

The field of the invention relates generally to a game, and in particular to an interactive game where participants make choices relating to various potential outcomes of a sporting event and, following the sporting event, prizes are awarded based on points obtained for correct choices.

### BACKGROUND OF THE INVENTION

Games relating to the prediction of sporting event outcomes are widely played. While these games relate to similar subject matter, they vary significantly in their design.

For example, U.S. Pat. No. 5,722,890 issued to Libby and Bower on Mar. 3, 1998, and entitled Lottery System, discloses a system that advantageously permits players to select game parameters from remote locations. The system generates the game based upon computer simulation and stored video. The game is then broadcast on television for public viewing.

U.S. Pat. No. 6,105,345 issued to Kail on Jan. 18, 2000, and entitled Conducting Games of Chance Using Predicted Sum of Scores, describes a game of chance based upon a plurality of sporting events. This game requires all events to be completed prior to awarding prizes.

U.S. Pat. No. 5,043,889 issued to Lucey on Aug. 27, 1991, and entitled Automated Golf Sweepstakes Game, describes an automated golf sweepstakes game where players predict the outcome of a golf tournament and, for the purposes of breaking a tie, the number of golfers that will shoot par. Entry information is provided on a printed coupon and the entries are read by a card reader or entered over a touch tone telephone.

U.S. Pat. No. 6,004,211 issued to Brenner et al. on Dec. 21, 1999, and entitled Interactive Wagering Systems and Processes, describes systems and processes for interactive off-track wagering. This system includes the provision of historical data, and allows for wagering on the outcome of an aspect, or combination of aspects, of a single event.

U.S. Pat. No. 5,782,470 issued to Langan on Jul. 21, 1998, and entitled Sports Game of Skill and Chance, describes a sweepstakes-type game using pre-printed game cards on which contestants predict the performance of selected players prior to an athletic event. The game cards can also be distributed by way of computer screens. Prizes are awarded based on a pattern created on the cards, or on points accumulated for correct predictions.

Alternative multi-player interactive games that provide more involvement by the player in the event are desirable.

### SUMMARY OF THE INVENTION

The invention consists of a method for playing a multi-player interactive game in conjunction with a single event, the single event having a plurality of sub-events, and each sub-event having a plurality of possible outcomes. According to one broad aspect of the invention, the method comprises the following steps. First, prior to the event, potential quantitative outcomes for sub-events are assigned to each of a plurality of predetermined categories. Numeric weights, used to calculate scores, are then assigned to each of the potential outcomes. Selections of potential outcomes, which attempt to predict actual outcomes for sub-events, are received from at least one player prior to the event. During the event, the score for the player is calculated by assigning points for each of the player's predicted outcomes that match actual outcomes, wherein the points correspond to the numeric weights assigned to each of the predicted outcomes. During the event scores are regularly updated and displayed. Once the event finishes, scores for each player are calculated.

According to another broad aspect of the invention, there is provided a system for playing a multi-player interactive game in conjunction with a single event, the single event having a plurality of sub-events, and each sub-event having a plurality of possible outcomes. According to one broad aspect of the invention, the system comprises means for assigning to each of a plurality of predetermined categories, potential quantitative outcomes for sub-events. The system also comprises means for assigning numeric weights to each of the potential outcomes, whereby the weights are used to calculate scores. Means are provided for receiving from a player, selections of potential outcomes which attempt to predict actual outcomes for sub-events. The system includes means for calculating the score for the player by assigning points for each of the player's predicted outcomes that match actual outcomes. The points awarded correspond to the numeric weights assigned to each of the predicted outcomes. The system regularly updates the scores during the event and displays the updated scores during the event. The system also calculates the score for each player.

In an illustrative embodiment of the present invention the method may further comprise the step of, prior to receiving selections from a player, providing the player with an option to obtain statistical information to assist the player in selecting potential outcomes for each category.

With respect to a further illustrative embodiment of the invention, the method may further comprise the step of charging the player a fee to view the statistical information if the player elects to obtain the statistical information.

With respect to yet further illustrative embodiments of the present invention, the system may have means for providing the player with an option to obtain statistical information to assist the player in selecting potential outcomes for each category. The system may also have means for charging the player a fee to view the statistical information if the player elects to obtain the statistical information.

### BRIEF DESCRIPTION OF THE DRAWINGS

For a better understanding of the present invention and to show more clearly how it may be carried into effect, reference is now made, by way of example, to the accompanying drawings which show a preferred embodiment of the present invention and in which:

FIG. 1 is a flow chart diagram of the steps required to set up a game in accordance with the preferred embodiment,

FIG. 2 is a flow chart diagram of the steps required to enter the game of FIG. 1 using a kiosk,

FIG. 3 is a flow chart diagram of the steps required to enter the game of FIG. 1 using a telephone,

FIG. 4 is a flow chart diagram of the steps required to enter the game of FIG. 1 using the Internet,

FIG. 5 is a flow chart diagram illustrating game administration during an event with which the game of FIG. 1 is associated,

FIG. 6 is a diagram of a typical installation of a kiosk according to the preferred embodiment of the invention,

FIG. 7 is a front left perspective view of a kiosk,

FIG. 8 is an image displayed during the game which is used to make choices for the “pick the winner” category, showing “NYY” selected as the predicted winner,

FIG. 9 is an isolated view of the statistical information display area of the screen showing statistical information relating to the “Pick The Winner” category,

FIG. 10 is a screen image displayed at the beginning of the game,

FIG. 11 is a screen image displayed during the game which queries whether players have played the game before;

FIG. 12 is a screen image displayed during the game which permits players to enter their registration number (telephone number),

FIG. 13 is a screen image displayed during the game which permits players to create a secret code,

FIG. 14 is a screen image displayed during the game which permits players to enter a user name,

FIG. 15 is an example of a game receipt,

FIG. 16 is a screen image displayed during the game which permits players to select a sport,

FIG. 17 is a screen image displayed during the game which permits players to select an specific game for a sport,

FIG. 18 is an image displayed during the game which is used to make choices for the “pick the winner” category, showing “TBJ” selected as the predicted winner,

FIG. 19 is an image displayed during the game which is used to make choices for the “pick the first” category,

FIG. 20 is an image displayed during the game which is used to make choices for the “pick over or under” category,

FIG. 21 is an image displayed during the game which is used to make choices for the “pick your team” category,

FIG. 22 is an image displayed during the game which is used to make choices for the “pick yes or no” category,

FIG. 23 is an image displayed during the game which is used to make choices for the “pick for the cycle” category,

FIG. 24 is a table summarizing the available outcomes and the weighting criteria for the category “Pick the Winner”,

FIG. 25 is a table summarizing the available outcomes and the weighting criteria for the category “Pick the First”,

FIG. 26 is a table summarizing the available outcomes and the weighting criteria for the category “Pick Over or Under”,

FIG. 27 is a table summarizing the available outcomes and the weighting criteria for the category “Pick Your Team”,

FIG. 28 is a table summarizing the available outcomes and the weighting criteria for the category “Pick Yes or No”,

FIG. 29 is a table summarizing the available outcomes and the weighting criteria for the category “Pick for the Cycle”,

FIG. 30 is an isolated view of the statistical information display area of the screen showing statistical information relating to the “Pick the First” category,

FIG. 31 is an isolated view of the statistical information display area of the screen showing statistical information relating to the “Pick Over or Under” category,

FIG. 32 is an isolated view of the statistical information display area of the screen showing statistical information relating to the “Pick Your Team” category,

FIG. 33 is an isolated view of the statistical information display area of the screen showing statistical information relating to the “Pick Yes or No” category,

FIG. 34 is an isolated view of the statistical information display area of the screen showing statistical information relating to the “Pick for the Cycle” category,

FIG. 35 is an isolated view of a sample of rankings of all players as may be displayed on the kiosk monitor,

FIG. 36 is an isolated view of a sample of inter-establishment rankings as may be displayed on the kiosk monitor, and

FIG. 37 is an isolated view of a sample of within-establishment rankings as may be displayed on the kiosk monitor.

### DETAILED DESCRIPTION OF THE PREFERRED EMBODIMENTS

The preferred embodiment is an interactive, multi-player game relating to a specific event such as a sporting event. The sporting event has a plurality of sub-events, each sub-event having a number of possible outcomes. Prior to the commencement of the sporting event, players choose from a selection of possible outcomes in defined categories of sub-events. These categories of sub-events are called pick-categories. During the sporting event, player choices are compared against the actual outcome for each sub-event and points are awarded for correct predictions. At the end of the event, players with the most points may win prizes and cash provided by promotional partners, and achieve social recognition for success in the game. While no particular skill level is required to participate in the game, players with greater knowledge of a particular sporting event will generally be more successful. The preferred embodiment may also be applied to any other event, such as the Academy Awards, with sub-events whose outcomes can be objectively determined.

As described in greater detail below, the game may be played either on an interactive computerized kiosk 200 installed, for example, in licensed taverns and bars; through an interactive voice response (“IVR”) telephone system 202; or over the Internet 204. The preferred embodiment may alternatively be played using other devices such as a personal digital assistant, for example a Palm Pilot™, or an Internet enabled handheld wireless telephone. Because of the manner in which the game is structured and administered, and the means by which it is delivered to players, the preferred embodiment is a promotional game and is not intended to be construed as a gaming activity. The preferred embodiment therefore does not conflict with the gaming legislation of many jurisdictions.

For each game, statistical analysis and modeling are used to assign points to possible outcomes for each sub-event in each of a number of defined categories for the sporting event. Points are ultimately awarded if the actual outcomes for each sub-event match the choices made by players. Players who accumulate the most points are eligible to win promotional prizes within multiple groupings of competitors.

As discussed in greater detail below, a game administrator is responsible for setting up each game and administering the game during the event. The game is conveniently structured so that the game administrator may create different games and versions of games by changing one or more elements of the modular game structure. The administrator may change the event upon which the game is based. For example, the game may be based on a hockey game, a football game or any other event with a set of objective outcomes. For a particular event, the game administrator may alter the sub-events which form the basis for player choices. For example, if a baseball game is the event, the administrator may use one or more sub-events such as pick the winner of the game or pick the team that will score the first run.

There is a nearly limitless number of combinations and permutations of sub-events and outcomes for a given event.

The administrator also determines the number of points awarded for correctly choosing the outcome for a particular sub-event. By altering the points awarded, the administrator can control whether there are a large number of winners or a small number of winners for a particular game. Preferably, points are awarded so that a large number of players is close to winning but only a few actually win.

Two extreme opposite examples of how the game administrator may adjust the distribution of winners follows. To set up the game so that roughly half of all players win, the administrator may reduce the number of sub-events to one, with only two outcomes for the sub-event. For example, if a baseball game is used as the event, the sub-event could be “pick the winner”. For baseball, this sub-event has two possible outcomes: home team wins or visiting team wins. Thus roughly half of all players pick one or the other outcome and, at the conclusion of the game, half will be winners. On the other hand, to set up a game so that only one player wins, the game administrator may use known statistical modeling techniques to structure the sub-events, outcomes and points awarded so that very few players could win. If more than one player does win, then a tie-breaking mechanism could be applied so that there is only one winner. Typically, the number of winners falls somewhere in between the above two examples.

The preferred embodiment can be applied to any number of sports, such as soccer, baseball, hockey, basketball or football, or any other event with sub-events whose outcomes can be objectively determined.

The description of the preferred embodiment of the invention is based on a baseball game. The preferred embodiment is structured around a number of pick-categories. For baseball, the following six pick-categories are used: “Pick the Winner”, “Pick the First”, “Pick Over or Under”, “Pick Your Team”, “Pick Yes or No” and “Pick for the Cycle”. Each pick-category represents a category of variable outcomes for one or more sub-events. For each pick-category, players select one or more outcomes that they believe will occur during the baseball game. Players are awarded points depending on whether those outcomes actually occur. As described in greater detail below, the player with the greatest number of points wins the game.

The “Pick the Winner” category has two possible outcomes: home team wins or visiting team wins. However, if a player is correct in picking the winning team, that player has the opportunity to score additional “bonus” points. Bonus points are awarded to a player for correctly picking the manner in which the winning team wins. Players are permitted to make a choice of one outcome for each of the following three alternatives: winning team to win in nine innings or in extra innings; winning team to lead all the way or to come from behind to win; and winning team to shut out the opponent or not to shut out the opponent. Each possible outcome is assigned a different point value based on the competing teams' respective win-loss-tie records. Referring to FIG. 24, weighting of points for each outcome varies, ranging from the team with the best record (earning the least points in the category) to the team with the worst record (earning the most points in the category). The value assigned to any one of the outcomes varies according to the two teams' relative records.

The “Pick the First” category has a number of possible outcomes as determined by the game administrator before the game. Possible outcomes for this category include pick the first hit and pick the first run for each of the two competing teams. A fixed number of points is awarded for correctly choosing a particular outcome. A player could select the home team to score the first hit and select the visiting team to score the first run. If all these outcomes occur in the game then the player is awarded full points for this category. As with all categories, points awarded are not dependent on the number of players enrolled in the game.

Possible outcomes for the “Pick-Over or Under” category depend upon whether the frequency of a given sub-event is greater than, less than or the same as a value set by the game administrator. Outcomes are evaluated for three game segments: the first three innings, the second three innings and the balance of the game. For example, players receive points for correctly choosing that the number of hits in a given game segment is either over, under or the same as some stated value. Points awarded for each correct pick in the category are based on either a linear or non-linear scale, as chosen by the game administrator. For example, if non-linear scaling of points is used, participants may be awarded 10 points if they make one correct pick, 40 points if they make two correct picks, and 160 points for making correct picks for all three segments of the game. If linear scaling is used, then 10 points are awarded if one correct pick is made, 20 points are awarded if two correct picks are made, and 30 points are awarded for making correct picks for all three segments of the game.

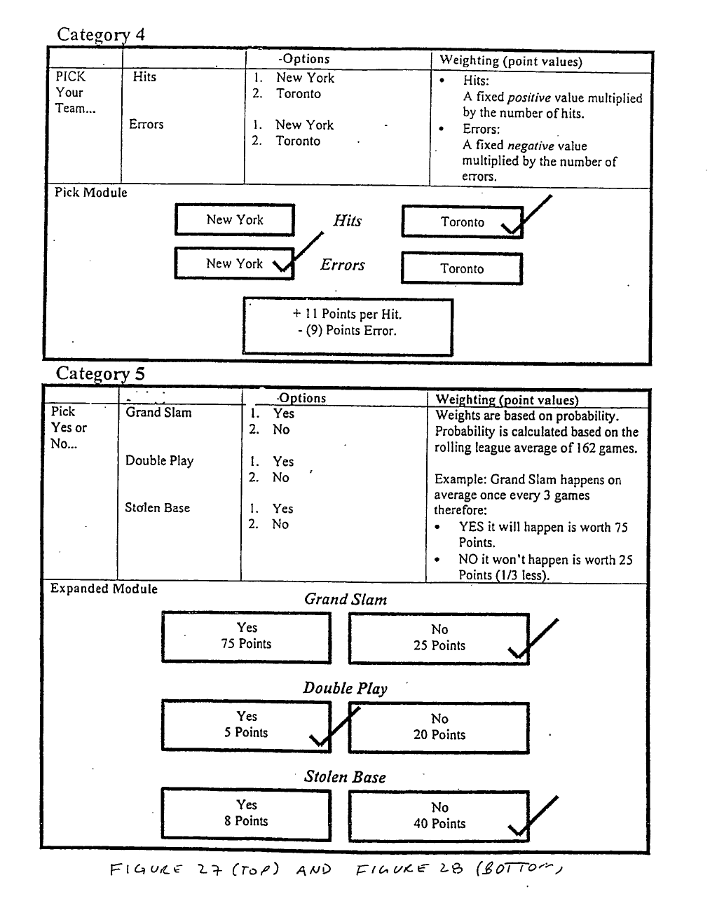

For the “Pick Your Team” category a fixed number of points is awarded for each occurrence of a sub-event by the team selected. For example, points are awarded for each hit by the chosen team and each error by the chosen team. Points may alternatively be subtracted for each error by a chosen team. Players must then choose the team that will commit the fewest errors in order to maximize their score. Other sub-events such as strikeouts and walks may also be used in this category. The number of sub-events in this category will vary at the discretion of the game administrator. Referring to FIG. 27, weighting for each outcome has either a fixed positive value (as in the case of hits, for example, two points) or a fixed negative value (in the case of errors, for example, minus three points). Points earned are calculated by multiplying the fixed value by the rate of occurrence of the outcome.

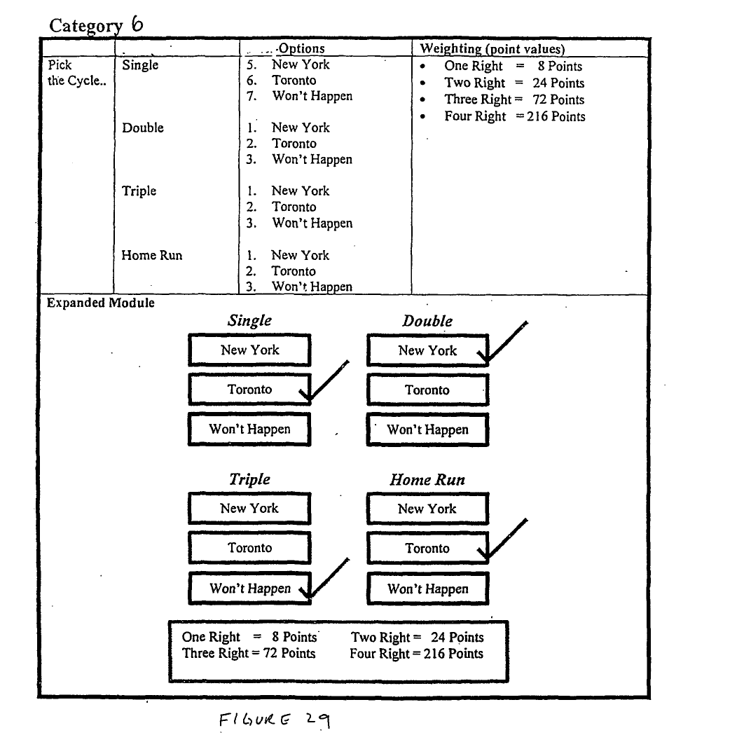

The “Pick Yes or No” category lists a number of possible sub-events that could take place within the baseball game, such as a “grand slam”, a “double play” or a “stolen base”. The objective of this category is to pick whether or not the featured sub-events occur at least once during the game. As with the “Pick the First” category, these sub-events may be changed from game to game by the game administrator to make the game fresh and exciting for repeat players. Referring to FIG. 28, weighting of points is scaled to the likelihood of occurrence of the sub-event.

The “Pick for the Cycle” category lists four sub-events: a single, a double, a triple and a home run. The objective is to pick which of the two competing teams will achieve the listed sub-events at least one time or not at all. As in “Pick Over or Under” category, points awarded for each correct pick in the category are based on either a linear or non-linear scale, as determined by the game administrator.

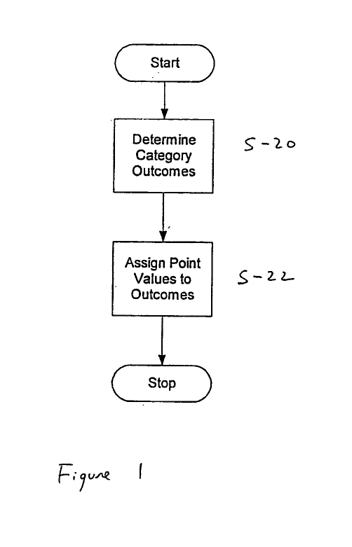

Referring to FIG. 1, before each game the game administrator determines the sub-events and respective outcomes to be assigned to each of the categories described above (step S-20). By varying the particular sub-events and possible outcomes used for each game, the game administrator can ensure that the game continues to be interesting and exciting from game to game. Before each game, the game administrator also determines the points to be awarded for correctly predicting the actual outcomes in each of the categories (step S-22).

The basis for the points awarded in each of the categories is similar. In general, in all categories less likely outcomes for a specific sub-event are allocated a greater number of points by the game administrator. The game administrator attempts to allocate points to outcomes so that as many players as possible are close to winning, the actual number of winners is small, and skilled players have a higher probability of winning than unskilled players. The points awarded for multiple occurrences of an outcome within a category may be variable, relative, or fixed, depending on the nature of the category. For each game, known methods of statistical analysis and modeling are used by the game administrator to determine the points that should be applied to the outcome variables in the pick categories. Points awarded do not depend upon the number of players enrolled in a game or on the particular selections that players make.

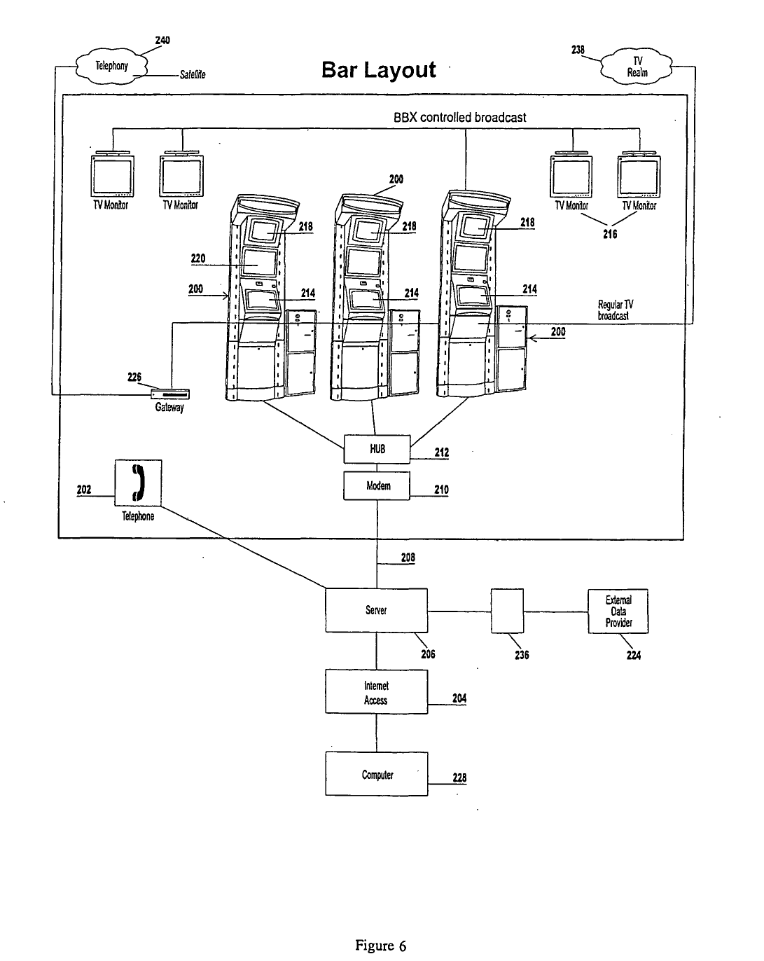

Once the game administrator sets up the game, players may enter the game in one of three different ways. Players may enter using an interactive kiosk 200 located in a commercial establishment (such as a sports bar that shows live televised sporting events), a telephone 202 or the Internet 204, as shown in FIG. 6.

Referring to FIG. 6, the preferred embodiment is delivered using an open architecture, client-server platform that networks remotely located kiosks 200 to a central server 206. The central server 206 may also be accessed from any computer 228 through the Internet 204 or using a telephone 202 located in a participating establishment. All server functions, including user verification, content administration, content access auditing, user tracking, and payment administration, are performed using well-known Internet technologies.

Administration of the game is done remotely by a game administrator over the network 208. Game software and data stored on the kiosks 200 are thus remotely maintained and updated via the central server 206 over the network connection 208 using an external modem 210 and external hub 212. During game play, data is regularly sent by the game administrator from the server 206 to permit client hardware within the kiosk 200 to calculate and display player scores and rankings on the kiosk monitor 218 and television monitors 216 located within a participating establishment. A third party supplier 224 provides game data.

The kiosk 200 itself is a “fat” client (i.e., the kiosk 200 stores locally most of the content required for its functionality) and is controlled by a standard personal computer (not shown) located within the kiosk 200. Because the kiosk 200 is a fat client and requires a relatively small data stream from the central server 206, it can be connected to the server using a regular telephone line for the network connection 208. In alternative embodiments of the game, the kiosk 200 may be configured as a “thin” client (i.e., most of the content required is stored remotely). In this configuration, the kiosk 200 is connected to the central server 206 using a high bandwidth connection means such as a digital subscriber line (“DSL”) or cable. A combination of connection means may also be used. For example, kiosks 200 located in one city could be connected using a regular telephone line, whereas kiosks 200 located in another city could be connected using DSL. Configuring the kiosk 200 as a thin client is more cost effective because most processing is done centrally by the central server 206.

Within a participating establishment, kiosks 200 are linked to the establishment's existing television monitors 216. The kiosk 200 itself may be configured to act as a server to display advertising on the establishment's television monitors 216 and the kiosk monitor 218. Advertising is downloaded from the central server 206 to the computer located within the kiosk 200. The establishment's cable feed 238 and/or satellite feed 240 are routed through a hardware gateway 226 before being transmitted to the kiosk 200. The gateway 226 enables the game administrator to remotely turn off the cable/satellite signal and substitute it with a private channel for broadcasting player scores, player rankings, and advertising to the establishment's television monitors 216 and the monitor 218 on the kiosk 200.

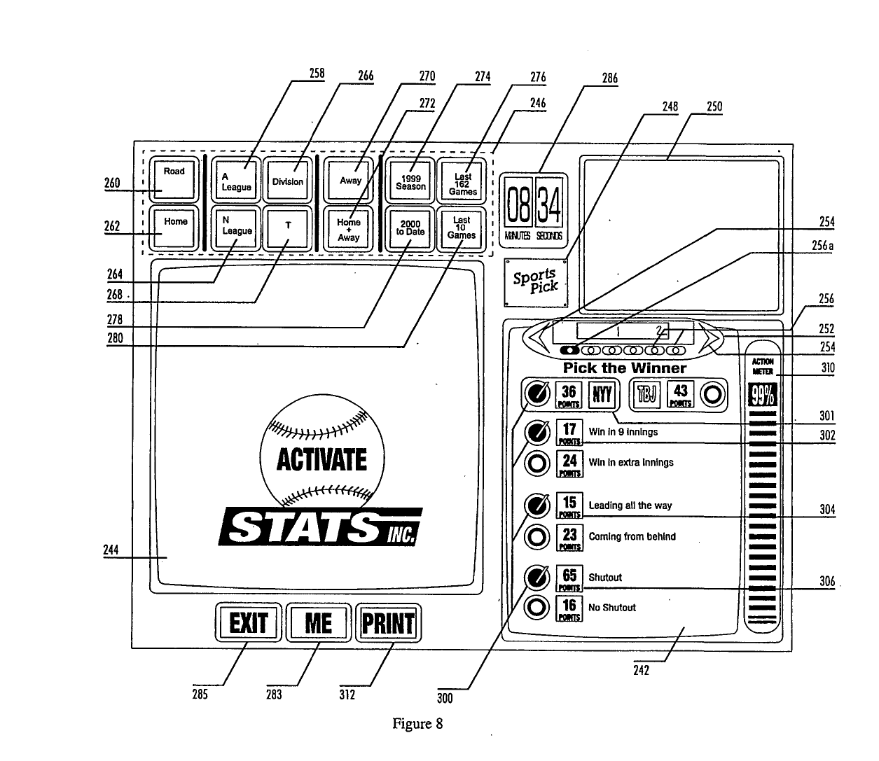

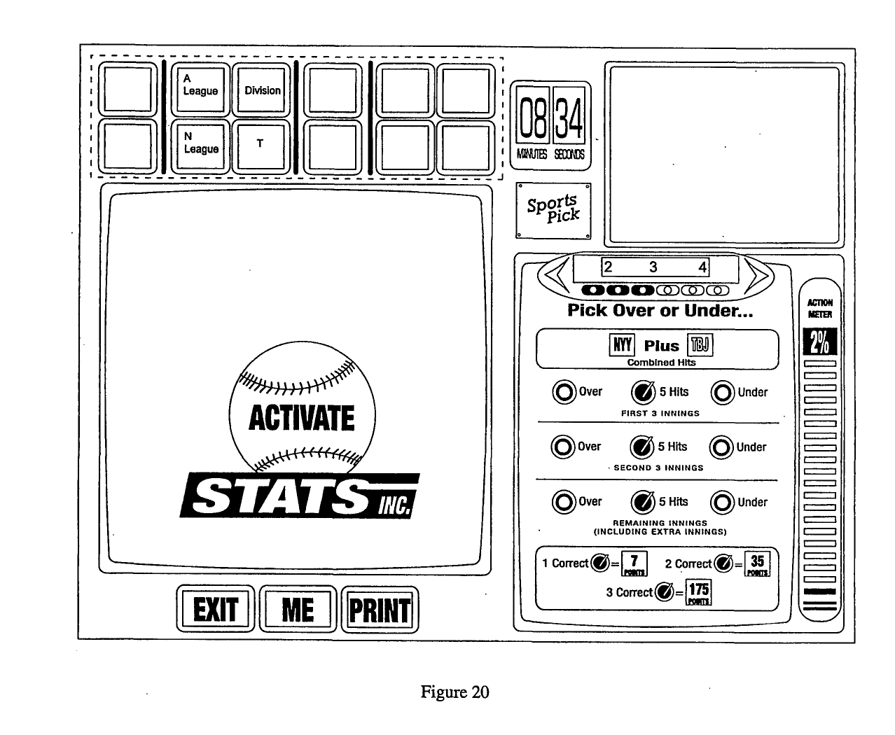

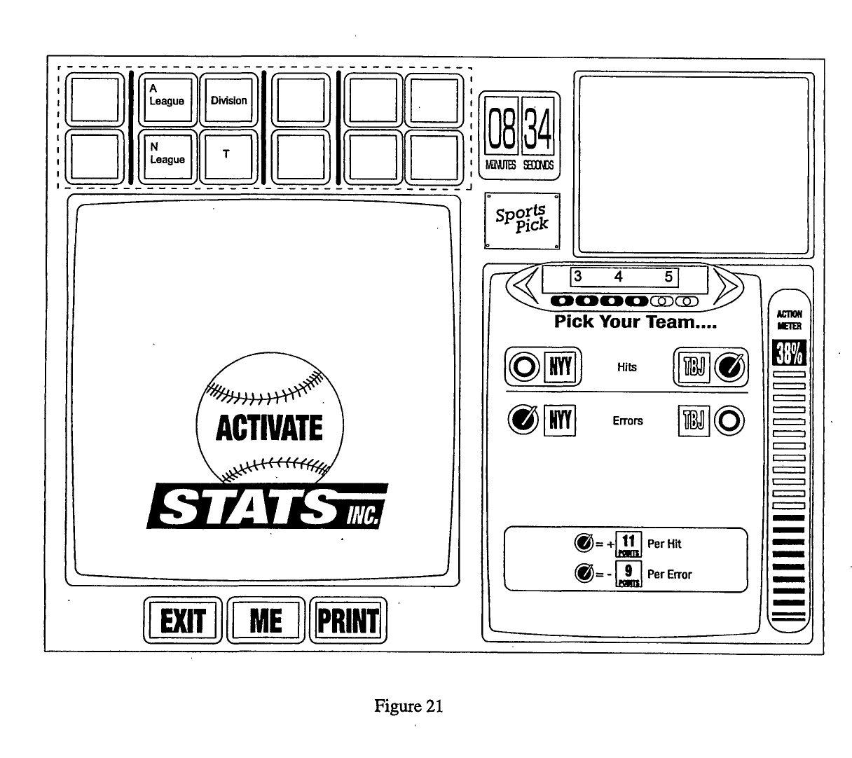

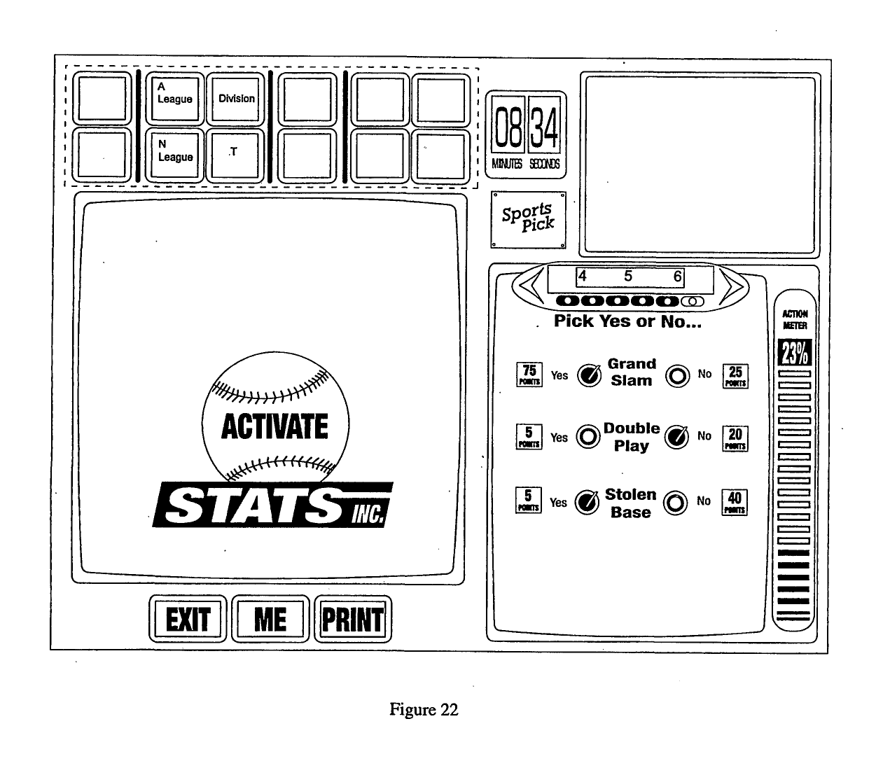

The kiosk 200 has a touch sensitive screen 214 that provides a means for players to enter information and to make choices. Referring, for example, to FIG. 8, the screen 214 may be divided into five areas: the game area 242, the statistical information display area 244, the statistical information selection area 246, a help button 248 and a multi-use display area 250. The multi-use display area 250 may be used to display at least one or more of the following: a live video feed of the sporting event as it-progresses, a help video to provide assistance to players, or advertising. Images similar to those displayed by the screen 214, and illustrated in FIGS. 8, 18, 19, 20, 21 and 22 may be displayed by other means, such as via the Internet 204 to a computer 228, or on the screen of an appropriately configured handheld wireless telephone (not shown). The game area 242 displays the sporting events available for game play and the categories from which selections may be made. A category indicator 252 indicates the number of the category from which selections are being made. Directional arrows 254 may be pressed on the touch sensitive screen 214 to scroll through the various categories. Six indicator lights 256 indicate whether selections have been made for a given category. For example, if the first indicator light 256a is not illuminated, then the corresponding category (i.e., the first category) has not been considered. If the light 256a is illuminated green then that category is presently being considered. If at least one pick has been made in the category, then the indicator light 256 illuminates red.

Touching the statistical information display area 244 activates the statistics function of the game. When a particular statistic is chosen from the statistical information selection area 246, the statistical information display area 244 of the screen 214 displays detailed statistical information relevant to the selection made. Players may review this statistical information and use it to select predicted outcomes for each category. An example of the functionality of the statistical information selection area 246 is provided below.

A player first chooses one of the two competing teams, either the road team or the home team. This is done by pressing the corresponding button, road 260 or home 262 within the statistical information selection area 246. Players then select the button corresponding to either the chosen team's record against American League teams 258, National League teams 264, teams that belong to the opponents division 266 or the chosen team's record against the opponent only 268. The division button 266 and opponent button 268 are identified by name, changing dynamically, depending on which team is chosen, to the name of the home team or the road team. Once these selections have been made, players must select the button corresponding to the location of the games played. Either the “home or away” button 270, or the “home and away” button 272 may be selected. The label of the home or away button 270 changes dynamically from either “Home” or “Away” depending on which team is initially selected. For example, if the road team button 260 is selected, then the label on the home or away button 270 would read “Away”. Selecting the home and away button 272, provides the chosen team's complete record both home and away. Finally, the games from which the statistics are to be compiled must be chosen. Players must choose one of the following four buttons: last season games 274, last 162 games 276, games this season to date 278 or last 10 games 280. The last season button 274 selects data from the chosen team's previous season, including playoffs. The last 162 games button 276 selects data from the chosen team's previous 162 games played, excluding playoffs. The season to date button 278 selects data from the chosen team's games played since first game of the present season. The last 10 games played button 280 selects data from the chosen team's previous 10 games played.

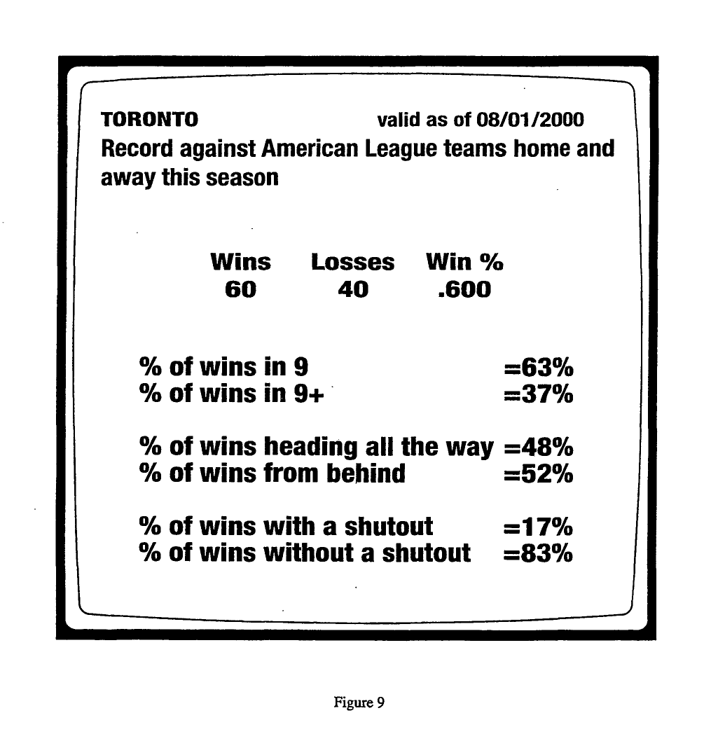

FIG. 9 provides an example of statistics that may be displayed in the statistical information display area 244 for the “pick the winner” pick category. FIG. 9 displays the relevant statistics when the following buttons are selected: the home team 262, Toronto, against teams in the American League 258, both home and away 272, in the present season 278. Note that the statistics provided correspond to the outcomes listed for the pick-category “pick the winner” shown in FIG. 8, as will be described below. The display of this statistical information contemporaneously with the pick category selections, helps the player to make selections within the pick category. Players may dynamically change the displayed statistics by choosing different buttons within the statistical information selection area 246.

The labels for the above-described buttons within the statistical information selection area 246 change when the game is applied to different events and may be changed by the game administrator for different games within the same sport.

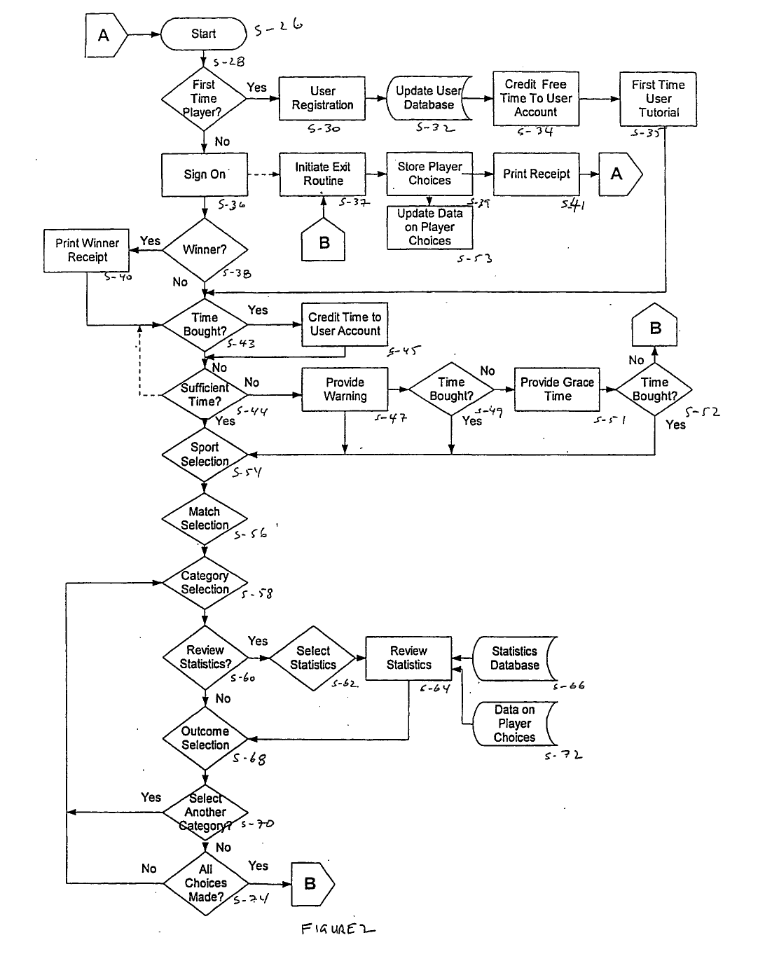

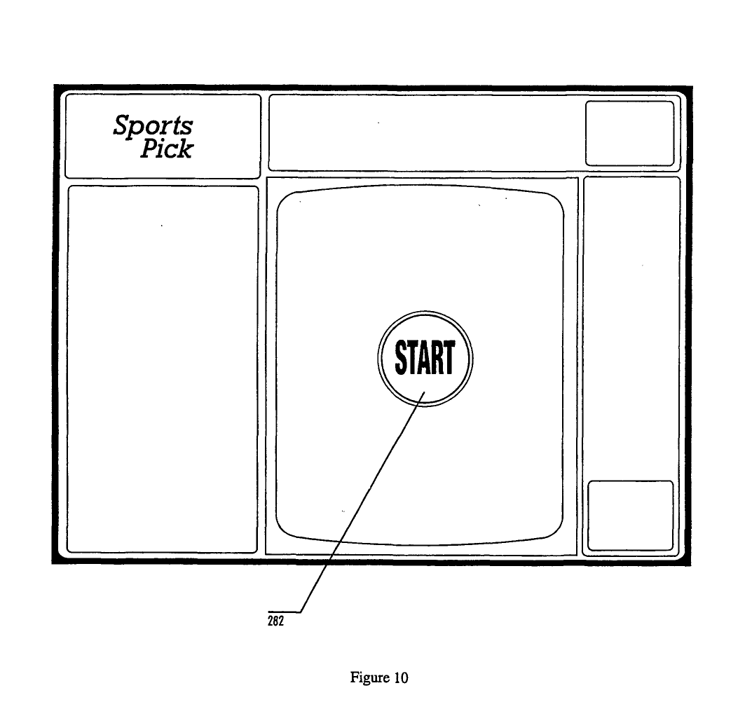

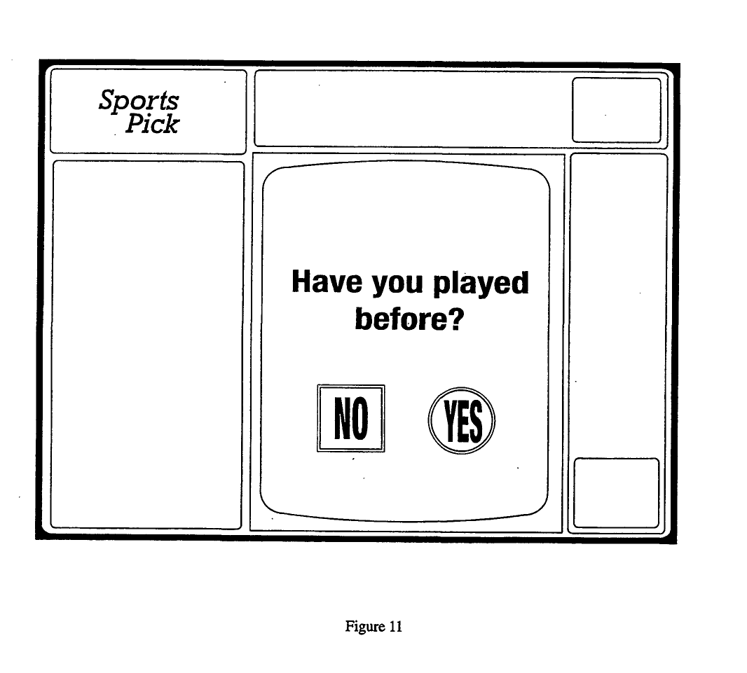

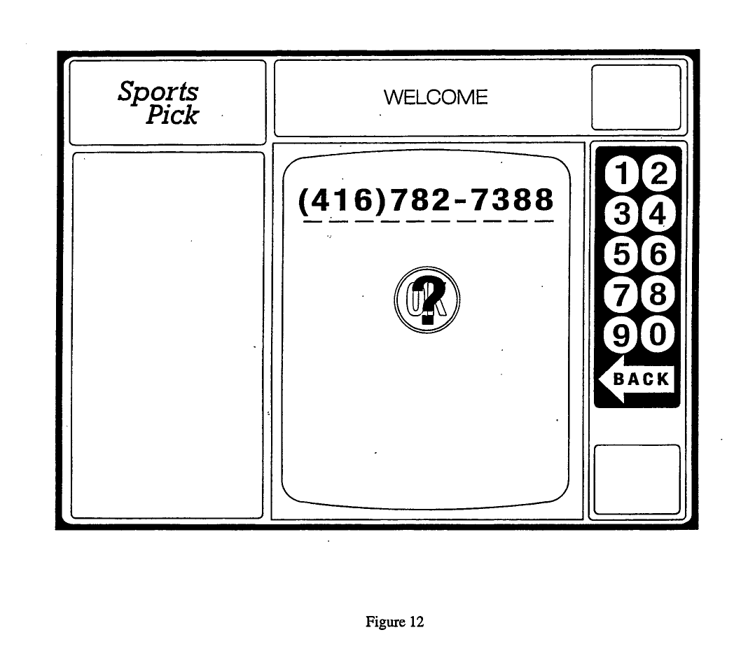

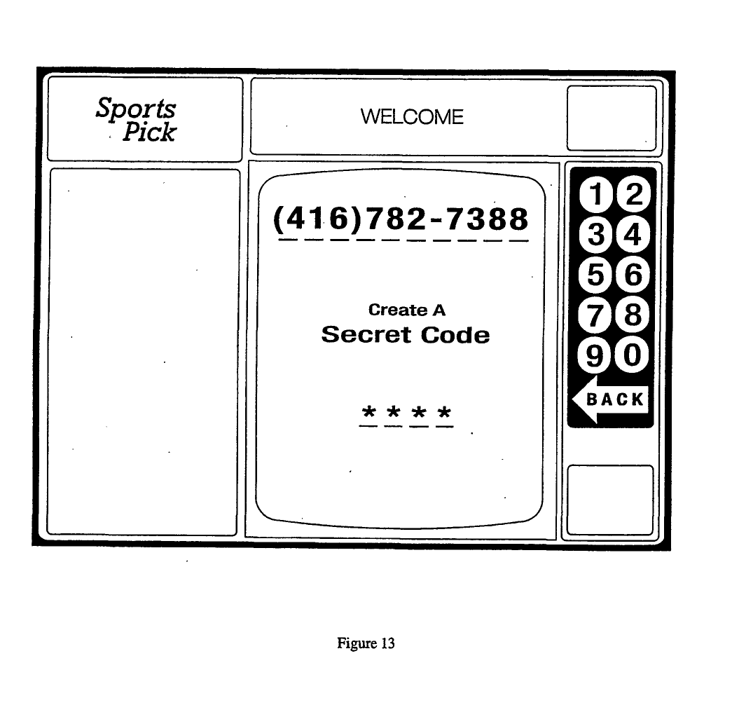

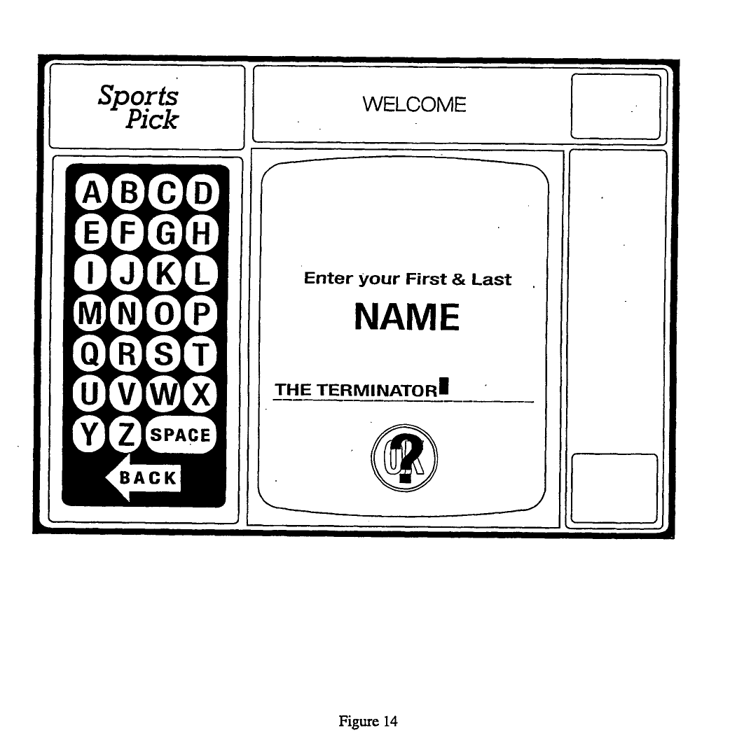

Referring to FIGS. 2 and 10, to start the game the specialized software program waits for a player to touch a play or start button 282 displayed on the touch sensitive screen 214 (step S-26). At this time (or at any other time) players may also be given the opportunity to view game rules and a list of upcoming games (not shown). As long as the start button 282 is not pressed, the specialized software program causes the touch sensitive screen 214 to display graphics promoting the game (not shown). Once the start button 282 is pressed in step S-26, the software queries whether the player is a first time player (step S-28; see FIG. 11). A first time player is someone who has never played the game on either a kiosk 200, a telephone 202 or the Internet 204. New users must first register (step S-30; see FIGS. 12, 13 and 14) before they are permitted to participate in the game. When registering, new players are required to complete the following steps: enter a ten-digit telephone number (see FIG. 12), choose a four-digit personal identification number (“PIN”; see FIG. 13), and enter a player name or pseudonym (see FIG. 14). The new player data is then stored in a user database (step S-32). In step S-34, first time kiosk players are allotted free on-line access time for their first session to permit them to become familiar with the game interface and to learn the features and rules of the game. First time players are also given a short on-line tutorial after they register (step S-35). Players who have played before do not need to register. They simply enter their ten-digit telephone number and four-digit PIN to identify themselves as registered players (step S-36). Registration information may be modified at any time by pressing the “me” button 283, shown in FIG. 8, for example. Once this is done, the player is presented with the registration screens described above.

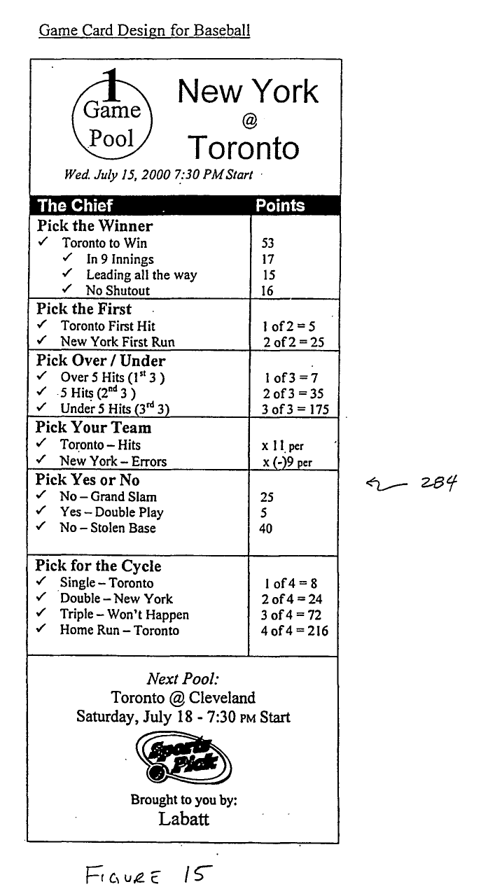

The dashed line between steps S-36 and S-37 indicates that the exit routine of step S-37 may be initiated by a player at any time by pressing the exit button 285, shown in FIG. 8, for example. If a player initiates the exit routine (step S-37) then the software stores the player's choices (step S-39), even if incomplete, updates data on player choices (step S-53), and prints a receipt 284 (step S-41). FIG. 15 shows a game receipt 284 where all choices have been made, as described in further detail below. Game receipt 284 may alternatively (or additionally) be presented electronically on screen 214 (not shown). This way, if a player makes multiple entries in a particular game, previous entries may be accessed electronically for comparison with the present entry. Once the game receipt 284 is printed, the software resets itself (returning to step S-26; see also FIG. 10). Players who exit in this manner have a very slight chance of winning because they have not made selections in every category and therefore cannot accumulate points in some categories.

In step S-38, the software automatically checks to see if the player is a winner from a previous game and, if so, if the player has been notified. If the player has won a previous game and has not yet been notified, the software in step S-40 instructs a printer 230 connected to the kiosk 200 to print a winner's receipt (not shown), which may be used to collect a prize. Once a winner's receipt is printed, the player may enroll in another game or initiate the exit routine (step S-37). If no choices have been made then no receipt 284 is printed in step S-41.

To enroll in the game using a kiosk 200, players are required to pay for the time that they use the kiosk 200 to enter their choices. Time credits may be purchased at any time. As described below, an advantage of paying to use the kiosk 200 is that pertinent statistics are provided which players may use to make their choices. At step S-43 the software evaluates whether the player has paid for time to use the kiosk 200. Payment may be made by depositing coins into a coin box 232 attached to the kiosk 200, or using a debit or credit card inserted into a card reader 234 attached to the kiosk 200. If time is purchased, then the player's account is credited with time (step S-45). Any time that is unused after all choices have been made is banked and may be used by the player for another game at a later date.

Whether or not time is purchased, in step S-44 a continuously looping algorithm, as indicated by a dashed line, verifies during every step in the process that the player has time available to make choices. The software also displays and continuously updates a timer 286 showing the time remaining as can be seen in FIG. 8. If the algorithm in step S-44 determines that a limited amount of time is available, for example 30 seconds, then the software warns the player that time is running out (step S-47; screen not shown). At this point players may continue making selections or buy more time. If no time is purchased (step S-49) and time runs out, the software indicates to the player that grace time will be provided (step S-51; screen not shown). Grace time is a period of a few seconds (10 seconds for example) that provides players with an opportunity to purchase more time. Players may not make selections during the grace period. If the grace period expires and there is no time available (for example, if the player does not buy more time) (step S-52) then the exit routine of step S-37 is automatically initiated and a game receipt 284 is printed (step S-41). Any time the exit routine is initiated (step S-37), even if a player has not finished making choices, the process may not be re-started at step S-26 to add to or to modify the choices already made. Instead, players must re-start the game at step S-26 and create a new game receipt 284. Each game receipt 284 constitutes separate entry in the game. A player may therefore enter the same game several times, thus improving the player's chances of winning. Five minutes before a sporting event begins, the system will not permit players to make choices.

In an alternative embodiment of the game, players may enter the game during the sporting event as well. For this arrangement, changes may not be made to categories where a given event has already occurred (for example, the “Pick the First” category may not be changed to pick the first team to score a goal if the first goal has already been scored).

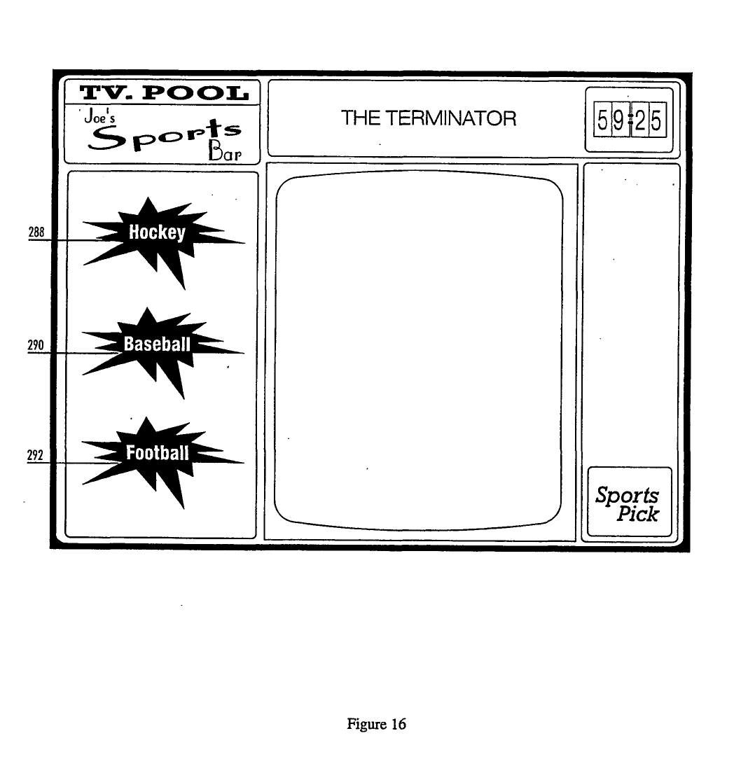

Once the software ensures that time is available (step S-44), players are prompted by the software to select the sport in which they wish to compete (step S-54). For example, FIG. 16 provides players with the choice of three sports. A particular sport is chosen by pressing the screen 214 area corresponding to one of the three sport buttons: the hockey button 288, the baseball button 290 or the football button 292. Of course, the game may be configured to display buttons for other sports as well.

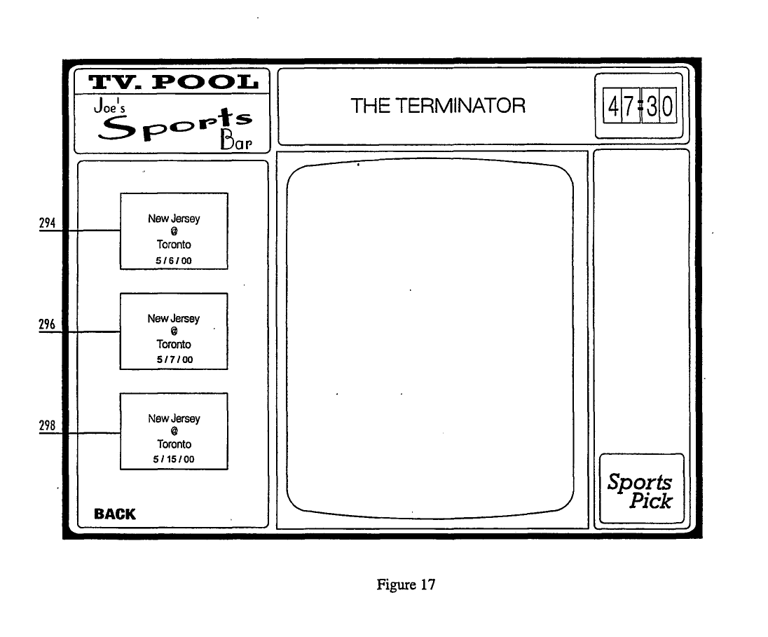

The software has the capacity to administer games for many different sporting events. This permits players to make their selections several days prior to an actual sporting event. Once the sport is chosen in step S-54, players are prompted by the software to choose from a number of select upcoming matches in that particular sport (step S-56). For example, if the hockey button 288 is selected from the screen shown in FIG. 16, then the event screen shown in FIG. 17 is displayed. This screen provides at least one button corresponding to an upcoming event for the sport chosen. In the sample screen shown in FIG. 17, players may choose either the New Jersey versus Toronto game button 294, the Buffalo versus New York button 296, or the Ottawa versus Toronto button 298.

Referring additionally to FIG. 8, in step S-58, players are prompted to select one of the pick-categories described above. As shown in FIG. 8, players are automatically presented with the first pick-category and may scroll through the different categories by pressing the directional arrows 254. Instructions on the touch screen 214, presented in the multi-purpose display area 250, guide the player through all the steps required to make a choice for a particular category (step S-68). Each category is customized for the particular match by the game administrator.

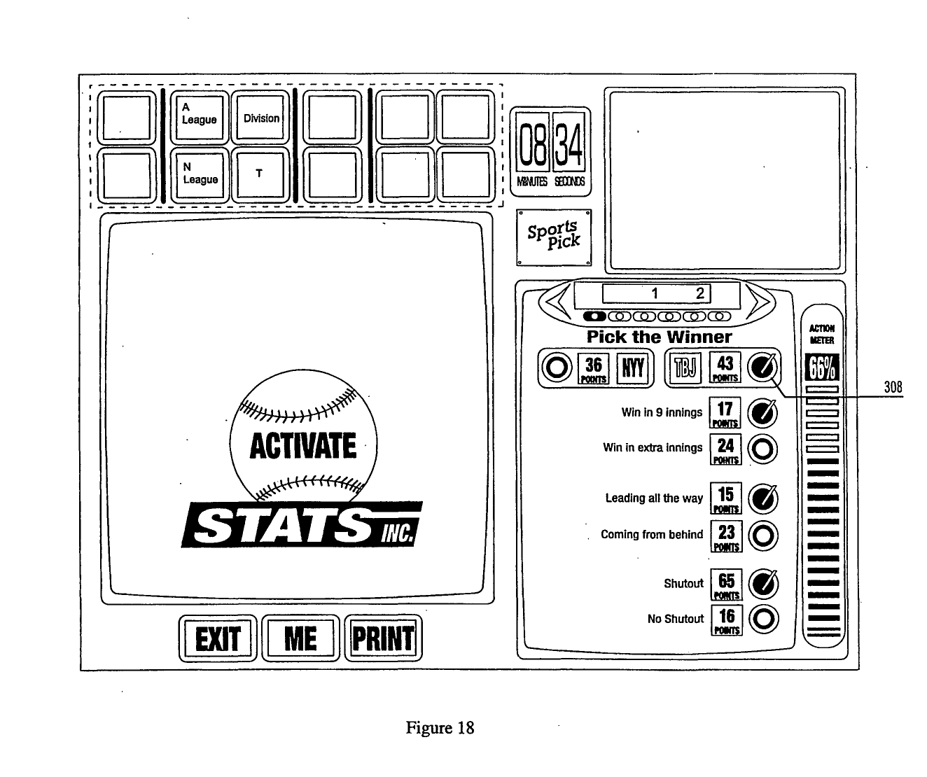

FIG. 8 illustrates the outcomes that may be selected in the game area 242. To select an outcome, a player need only press the touch sensitive screen 214 in the area of the outcome to be chosen. Once the selection is made, a check mark 300 is displayed beside the selection. As shown by the check marks 300, for the pick the winner category illustrated in the example screen of FIG. 8, the following buttons have been selected: New York Yankees (“NYY”) to win 301, in nine innings 302, leading all the way 304, with a shutout 306. Referring to FIG. 18, a displayed image similar to the one shown in FIG. 8 is presented, with the Toronto Blue Jays (“TBJ”) button 308 selected instead, indicating that the player predicts that the Toronto Blue Jays will win the event.

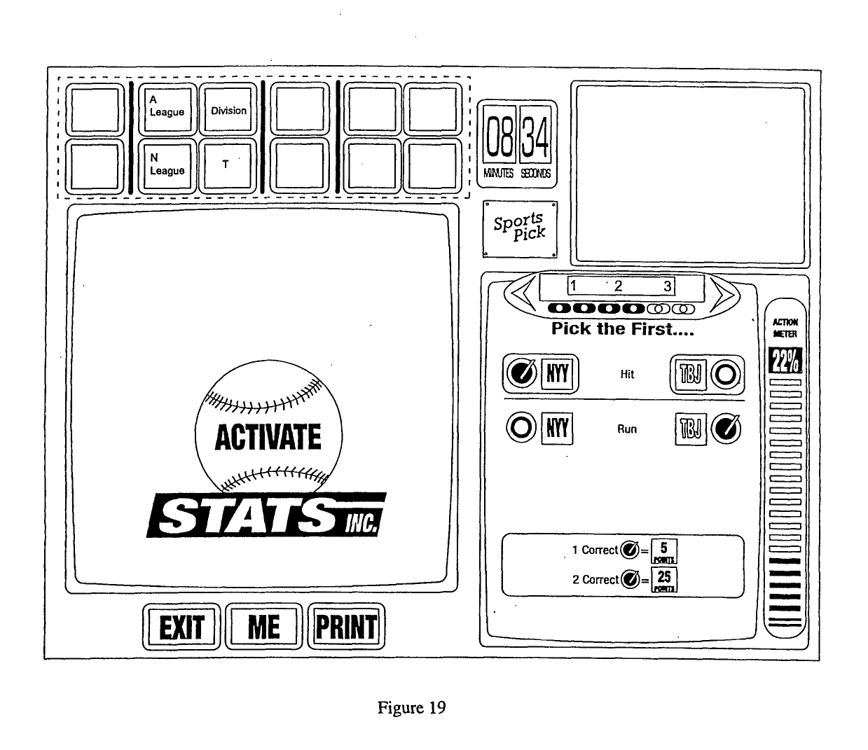

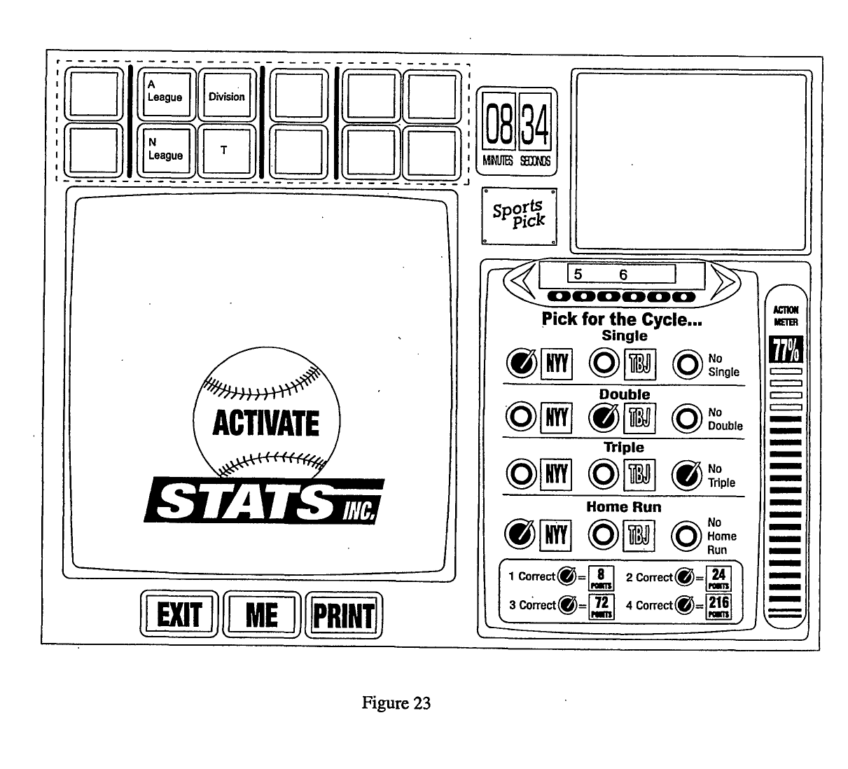

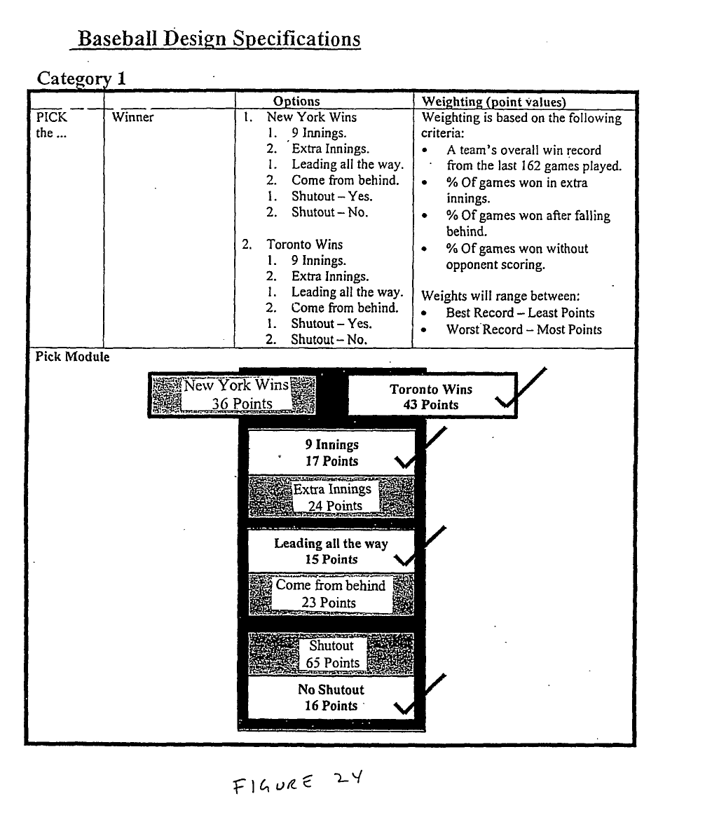

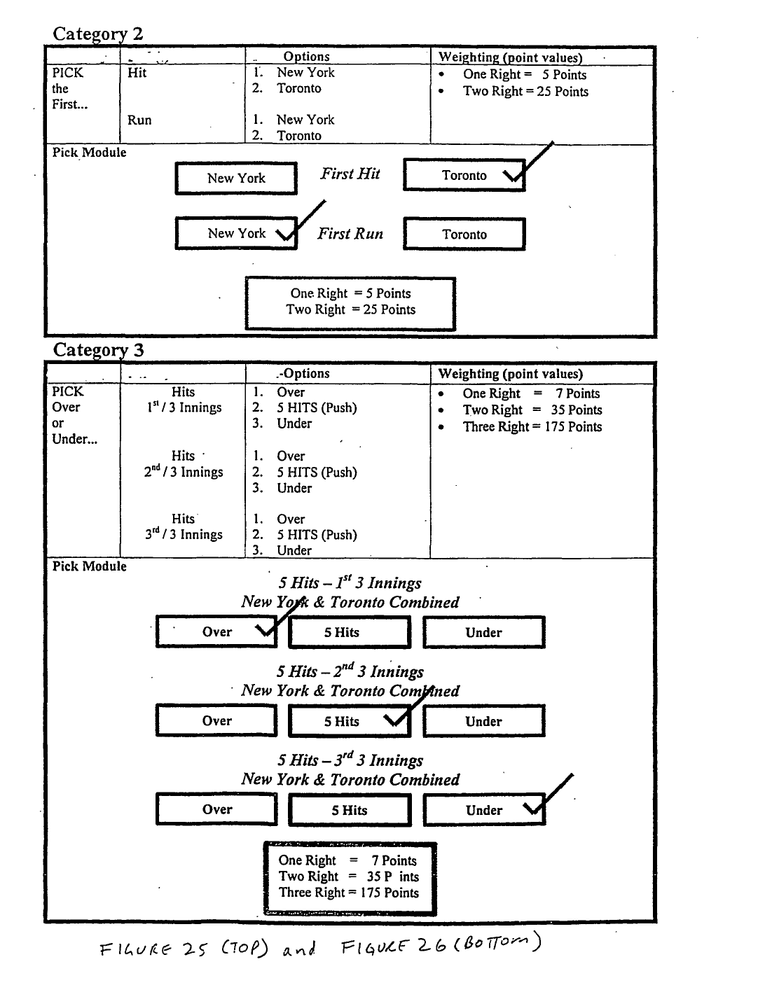

FIGS. 19, 21, 22 and 23, illustrate the screen images displayed for the remaining pick categories, “Pick the First”, “Pick Over or Under”, “Pick Your Team”, “Pick Yes or No” and “Pick for the Cycle”, described above. For each of the pick-categories, FIGS. 24, 25, 26, 27, 28, and 29 each provide a table summarizing the available outcomes, or options, that may be selected within each category. A sample block diagram illustrating choices that could be made is provided in each figure, as well.

Referring to FIGS. 8, 18, 19, 20, 21, 22 and 23, once a category is selected, players may review the points available for each of the options within the chosen category. Each option represents a possible outcome for the sub-event (or sub-events) in the category, as discussed earlier. For example, referring to FIG. 8, NYY button 308 is labeled “36 Points”. This means that if a player selects the New York Yankees to win, then the player will be awarded 36 points. As illustrated in all the applicable figures, the less the likelihood of an outcome occurring, the greater the points that are awarded in the event that the outcome does occur. In making their selections, players try to maximize the total number of points for selections made in all categories. To help players make their selections, players may review previously compiled up-to-date statistics and other historical data that relate to the particular category and choices available within that category (step S-60). Statistics are provided by an external statistics provider such as Stats, Inc. of Morton Grove, Ill. (step S-66). To streamline the presentation and operation of the game, for example, the statistical information may alternatively not be provided to players.

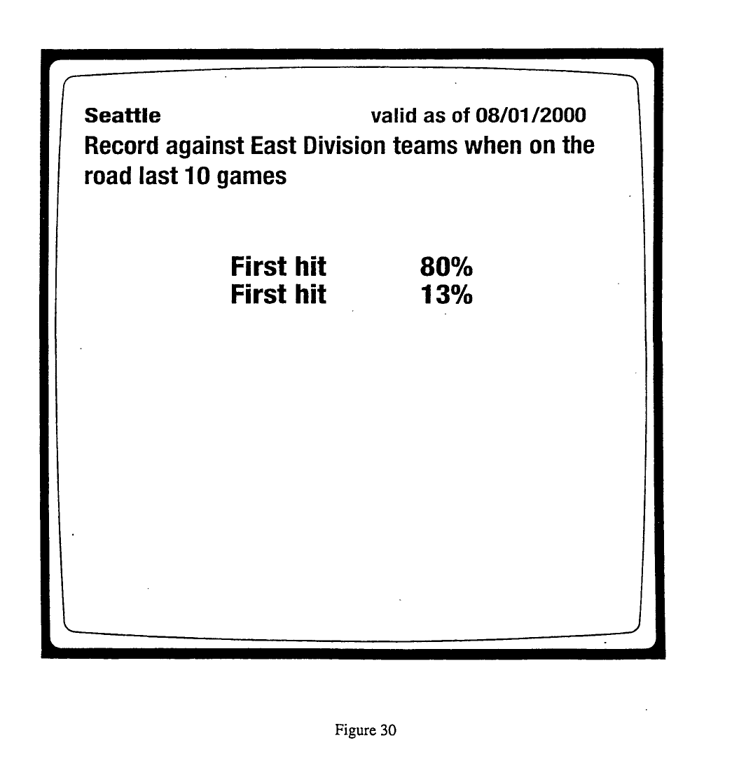

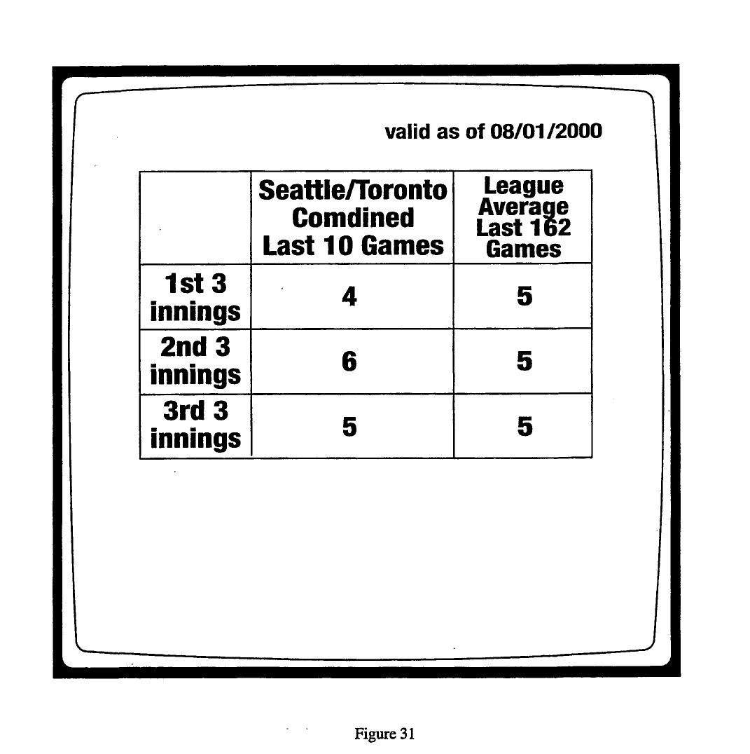

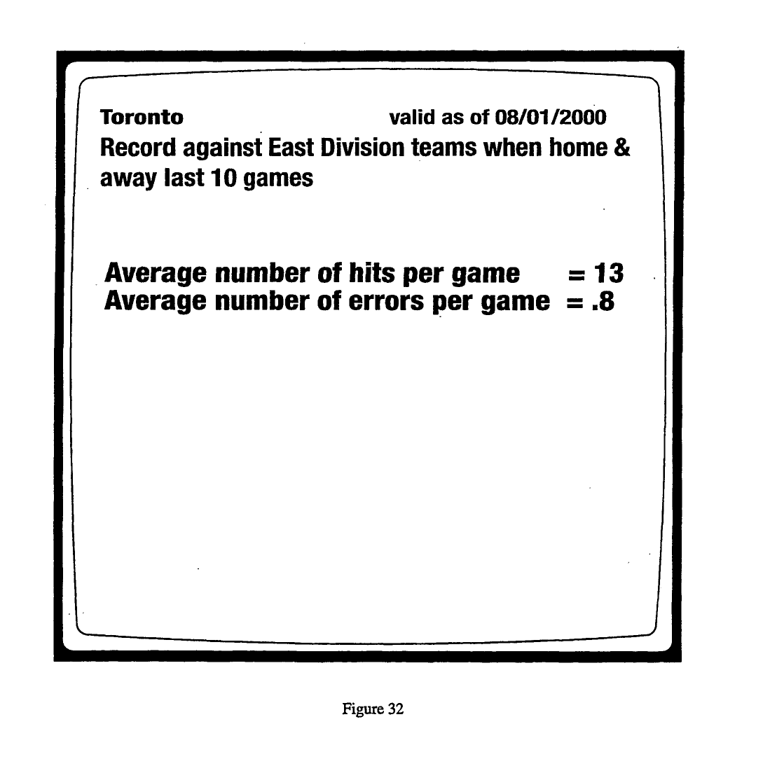

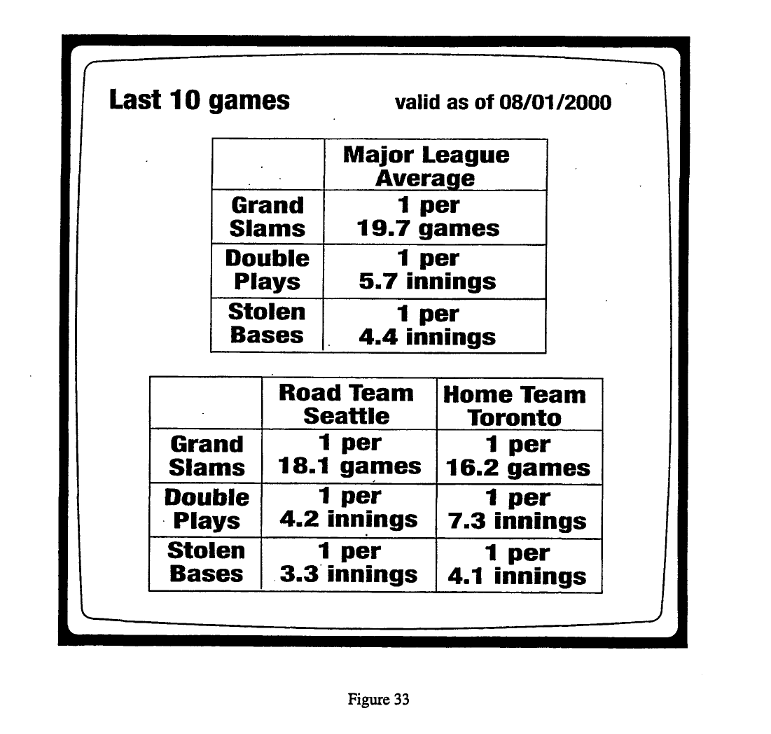

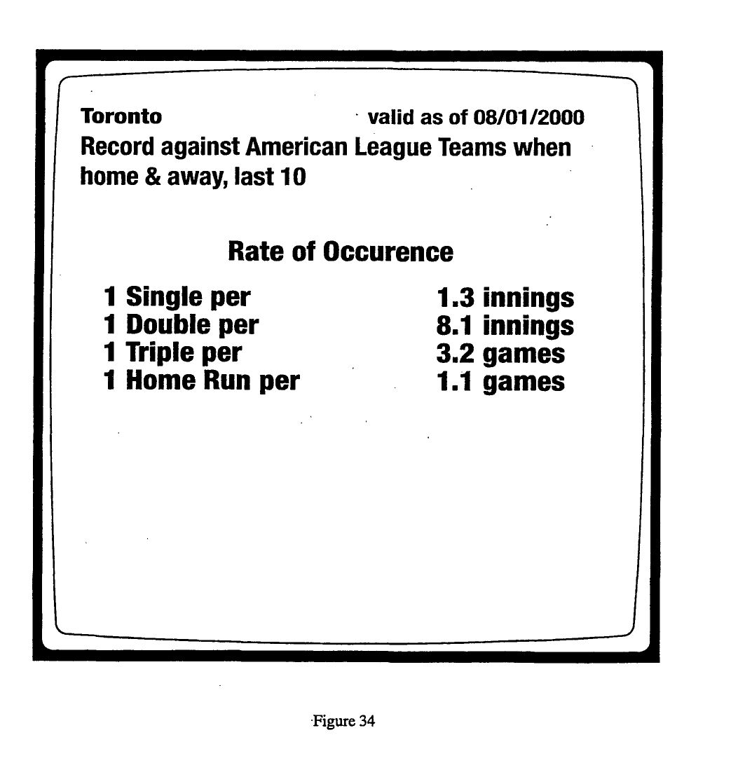

If statistics are provided, to review the available statistics (step S-64), interactive features of the kiosk 200 permit players to choose from a variety of statistics available for a particular category (step S-62). To review statistics players make selections from the statistical information selection area 246 as described above. Sample statistics, displayed in the statistical information display area 244, for each of the categories “Pick the Winner”, “Pick the First”, “Pick Over or Under”, “Pick Your Team”, “Pick Yes or No” and “Pick for the Cycle”, are provided FIGS. 9, 30, 31, 32, 33, and 34, respectively. The statistics are presented in a clear, easy to understand format using a combination of text and graphics such as bar charts. For example, to make a selection for the category “Pick the Winner” contestants may choose to view win/loss statistics for each team as shown in FIG. 9. The win/loss statistics that may be selected for each team are based on data for the two teams in previous games against each other, against teams in the same division, and against all teams in the league. As discussed above, statistics may be provided for the current and previous seasons. If the statistics show that one team is more likely to win, then a player may use this information to pick that team for this category. On the other hand, more points are typically awarded for events that are less likely. A player may therefore choose the least likely team to win in an attempt to maximize points.

Referring for example to FIG. 8, players may also review in step S-64 an action meter 310 which displays a summary of the choices previously made by other players in the same game for each possible selection within a category. The meter 310 automatically displays the data relevant to the particular selection, or outcome, when the button for that outcome is touched. In the sample screen shown in FIG. 8, the action meter 310 shows that 99 percent of players chose the New York Yankees to win.

These data are drawn from a database of player choices (step S-72). This information provides insight into how other players have interpreted the statistical information, which may further inform a player's selections for a given category.

As noted above, the statistics feature is available only with kiosk entry in the game. The access fee pays for the convenience and benefit of having the statistical information gathered, analyzed, and available for making selections within each category. A key to success in the game is the interpretation of this statistical information by the player. Players may also use the statistical information to develop their own strategies for making picks in the game. Of course, players may skip the statistical review and make choices based upon their own knowledge. If a player does not wish to use the statistical information, or would like to save money, choices may be made at no cost by using a telephone 202 located near the kiosk 200 (described in further detail below). The free telephone access to the game has the added benefit that it permits the game to comply with the gaming laws of many jurisdictions that require that access to the competition be free.

Once statistics are reviewed, players enter their choices for the category in step S-68 (illustrated for each category by check marks 300 in FIGS. 8, 18, 19, 20, 21, 22 and 23). At this point players may select another category (step S-70) and repeat the above process starting at step S-58. Once a player has finished making selections for all categories (step S-74), the software permits the player to select the print option button 312 which initiates the exit routine in step S-37, described earlier, providing a receipt 284, shown in FIG. 15. Alternatively, a player may at any time initiate the exit routine directly (step S-37) by pressing the exit button 285. In either case, the printed receipt 284 records the following: the upcoming televised sporting event for which the selections were made, a list of the selections made, the available points for those selections, and the player's name or pseudonym. Receipts 284 may also advertise the next event, the name of a sponsor, or any other information. The receipt 284 serves as a memory aid to players by providing a printed record of their picks to refer to when they subsequently watch the televised sporting event unfold. This builds excitement because players may compare game receipts 284 with each other, and actively compare picks made to outcomes for the various sub-events of the game as the game progresses. At the end of the sporting event, a winning player may return to the kiosk 200 and a winner's receipt will be automatically printed once the user signs on and the software confirms that the player is a winner (steps S-26 to S-40). Players who use telephone access to play may obtain a winner's receipt from a kiosk 200 in the same manner.

To be treated as a promotional game for legal compliance purposes, players may use a designated touch tone pay telephone 202 located in the same establishment as the kiosk 200 to make selections using an interactive voice response system (“IVR”), as shown in FIG. 6. The IVR system is a menu driven telephone system that permits players to navigate the various categories using the telephone keypad (not shown) and to make selections following a similar process to the one described above for kiosk play. Enrollment is free for the cost of the call.

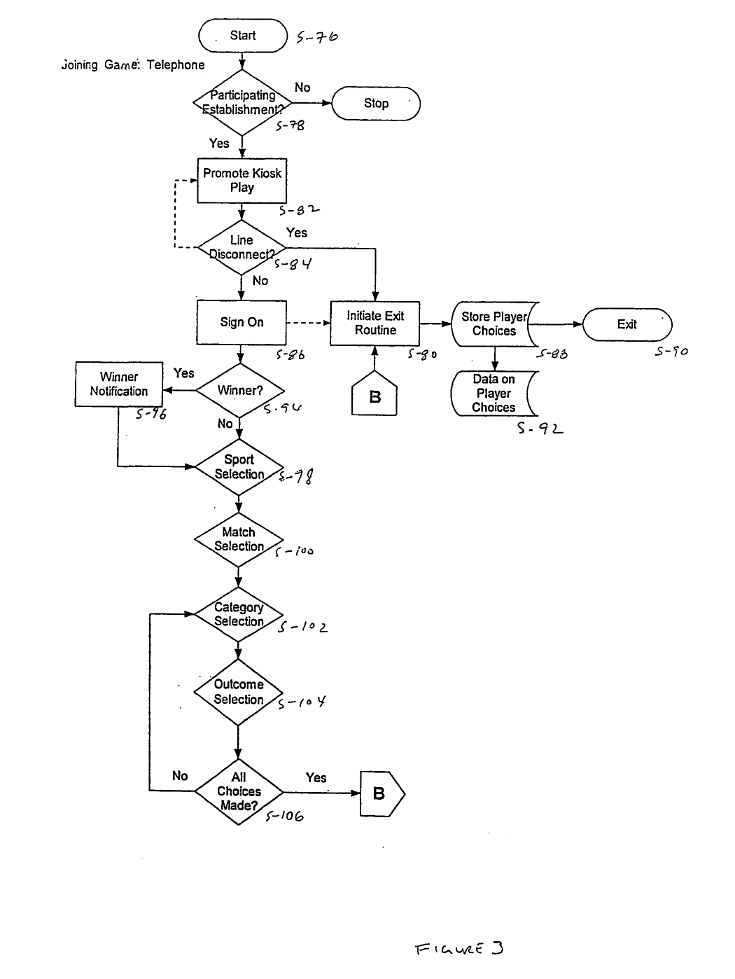

Referring to FIG. 3, to enter the game by telephone 202, players dial a toll free number (step S-76).

When connected, the IVR system first checks the telephone's caller identification (“caller ID”) to verify that a designated telephone 202 located at a participating establishment is being used (step S-78). If the caller ID is invalid then the call is disconnected by the system software (step S-80).

A recorded message promoting the benefits of kiosk play, such as the ability to access statistical information to increase chances of winning, is played intermittently throughout the telephone IVR process as illustrated by the dashed connection between steps S-80 and S-84. If the caller hangs up then the exit routine is initiated (step S-80) and player choices, if any, are stored in a database (step S-88), data on player choices are updated (step S-92) and the system electronically disconnects from the telephone 202 (step S-90).

In step S-86, players enter their registration information using the telephone keypad. In the preferred embodiment all first time players register using the kiosk 200. As noted earlier, the kiosk 200 provides instruction and free time to new-players (steps S-34 and S-35). Once a player has signed on using the telephone 202, a software routine checks the player's registration information against a list of winners who have not been notified (step s-94). If the player is a winner and has not been notified, then a recorded message is played stating that the player is a winner and that a winner's receipt may be obtained from a kiosk 200 (step S-96).

Regardless of whether the player is a winner, the IVR system prompts the player to select a sport and lists the sports available (step S-98). In the same manner that a sport is selected, a match is selected in step S-100. The player is then prompted to choose the first category in which they would like to make selections (step S-102). As with kiosk entry, players may make selections in any or all categories and may change their selections at any time up to five minutes before the sporting event begins as long as the exit routine has not been initiated in step S-80.

Once the category has been chosen (step S-102), the IVR system then prompts the player to make selections in the given category (step S-104). Because telephone enrollment is free, the IVR system provides no access to the statistical information available using the kiosk 200. Once choices are made in one category the IVR system iteratively guides the player through the remaining categories (step S-106). When all choices have been made, or the player chooses not to make selections in every category (step S-106), the exit routine is initiated (step S-80).

In an alternative embodiment (not shown), a time limitation may be placed on telephone enrollment. For example, a routine in the nature of steps S-44, S-47, and S-51 of FIG. 2 may be implemented to limit the amount of time that a user may take to enroll. Once the allotted enrollment time expires, the exit routine in step S-80 is initiated. Note that in the alternative embodiment, players may not pay for extra time because telephone enrollment is free. By limiting the time for players to enroll, system resources may be conserved.

The game structure for delivery over the Internet 204 may be fundamentally the same as kiosk play.

However, instead of providing direct access to statistical information as in kiosk play, a game pack may be purchased by Internet players. The game pack provides statistics in the same manner as in kiosk play. Since Internet players are charged a flat fee for the game pack, there is no time limitation when enrolling via the Internet 204. The game pack expires once players have made their selections. Internet players may optionally enroll in the game free of charge by not purchasing the game pack. This helps to ensure that the game complies with a requirement of gaming legislation that free enrollment be provided. This requirement is satisfied for kiosk enrollment because a telephone 202 providing free enrollment is always located in the same establishment as a kiosk 200. Internet games, while based on the same sporting event as the kiosk game, are run separately with different contestants and different prizes.

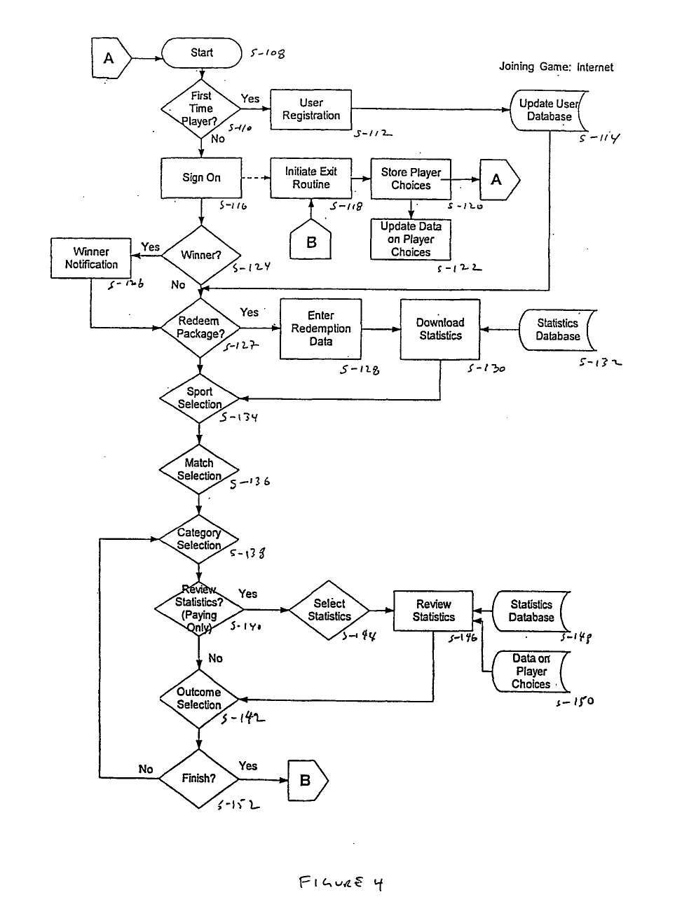

Referring to FIG. 4, players enroll in the game via the Internet 204 by first accessing the home page of a proprietary Internet web site (Step S-108) which guides the player through the enrollment process in substantially the same manner as for kiosk play. The various screen images presented to players are substantially similar to those described above for enrollment via a kiosk 200. Instead of requiring a touch sensitive screen, selections may be made by using a using a mouse (not shown) and positioning the mouse pointer on the desired selection and clicking. This has the same effect as pressing a given button on the touch sensitive screen 214 of the kiosk 200, as described above.

The software first queries whether the player is a first time player (step S-110). First time players must first register (step S-112) before they are permitted to participate in the game. When registering, new players are required to: enter a ten-digit telephone number, choose a four-digit personal identification number (“PIN”), and enter a player name or pseudonym. The new player data is then stored in a user database (step S-114). Players who have played before do not need to register. They simply enter their ten-digit telephone number and four-digit PIN to identify themselves as prior players (step S-116).

The dashed line between steps S-116 and S-118 indicates that a player may initiate the exit routine of step S-118 at any time. If a player initiates the exit routine (step S-118) then the system software completes the following steps: it stores the player's choices (step S-120), even if incomplete, updates data on player choices (step S-122), and then resets itself returning to the home page of step S-108. As noted earlier, players who exit in this manner have a very slight chance of winning because they have not made selections in every category and therefore cannot accumulate points in some categories.

In step S-124, the software automatically checks to see if the player is a winner from a previous game and if the player has been notified. If the player has won a previous game and has not yet been notified, the software in step S-126 notifies the player that they have won an earlier game. The player may enroll in another game or initiate the exit routine (step S-118).

Following the sign on procedure (step S-116), players may redeem a game pack (step S-127). Codes for redeeming a game pack may be purchased at any time before enrolling in a game. Codes may be purchased either on-line from the proprietary web site or in person at a participating retailer. To redeem a game pack, the purchased code is entered in step S-128. Statistics are then downloaded (step S-130) from a statistics database (step S-132) located on the proprietary web site. Once the sporting event begins, players who redeem a game pack are also provided with data relating to the sporting event as it occurs, and are provided with the standings of the game players with the highest scores. In an alternative embodiment of the game, a streamed live video feed of the sporting event is also provided. Players may alternatively enroll in the game without purchasing a game pack and continue to step S-134.

In step S-134, the software prompts players to select the sport in which they wish to compete. The software has the capacity to administer games for many different sporting events. Unlike kiosk play, Internet players may only enroll in a game on the day of the sporting event. Once the sport is chosen in step S-134, players are prompted by the software to choose from a selection of the day's upcoming matches in that particular sport (step S-136).

In step S-138, players are prompted to select one of the six categories described earlier. Instructions guide the player through all the steps required to make a choice for a particular category (step S-142). The game administrator customizes each category for the particular match. Once a category is selected, players may review the points available for each of the options within the category. As with kiosk play, each option represents a possible outcome for a sub-event in the category. In making selections players try to maximize the total number of points for selections made in all categories.

If a game pack has been redeemed in step S-127, players may choose to review the downloaded statistics that relate to a given category and choices available within that category (step S-140). Statistics are provided by an external statistics provider such as Stats, Inc. of Morton Grove, Ill. (step S-148).

To review the available statistics (step S-146), interactive features of the web page permit players to choose from a wide variety of statistics available for a particular category (step S-144). The statistics are presented in a clear, easy to understand format using a combination of text and graphics such as bar charts. Statistics may be used in the same manner as described for kiosk enrollment. Players may also review in step S-146 an action meter which displays a summary of the choices previously made by other players in the same game for each possible selection within a category. These data are drawn from a database of player choices (step S-150). This information provides insight into how other players have interpreted the statistical information, which may further inform a player's selection for a given category.

Once statistics are reviewed, players enter their choices for the category in step S-142. At this point players may select another category (step S-152) and repeat the above process starting at step S-138, or players may choose to finish part way through the selection process and initiate the exit routine in step S-118.

If players have completed making their choices but want to change them, they may at any time up to five minutes before the sporting event begins change any selection previously made as long as the exit routine has not been initiated in step S-118.

In an alternative embodiment of the game, players may enter the game during the sporting event as well.

Changes may not be made to categories where a given event has already occurred.

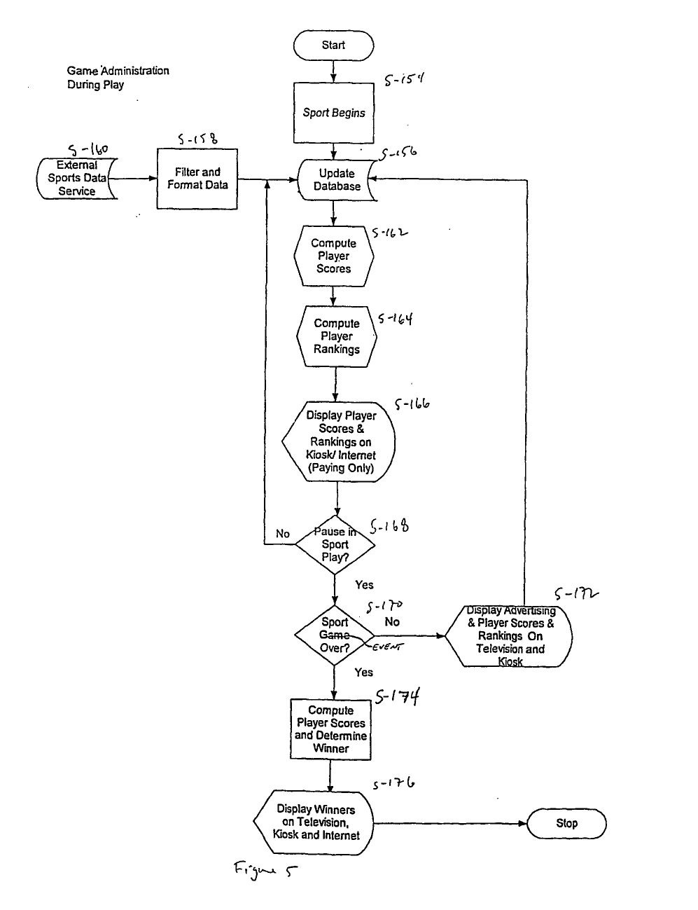

Referring to FIG. 5, once the sporting event begins (step S-154), a database 236 containing data pertaining to the sporting event is updated in near real time as the sporting event progresses (step S-156). The data originate with an third party sports data service 224 (step S-160) and are filtered and formatted by specialized software located on the server 206 (step S-158). The filtered data are compared with each player's selections to compute and update each player's score. Points are awarded based on actual results from the sporting event as the event progresses. As the outcomes for sub-events within each category take place, points are credited in near real time to players' scores. For example, if the filtered data indicate that there has been a run by the home team, putting the home team in the lead, then players who selected home team to win in the “Pick the Winner” category will be awarded points for correctly choosing the winner. Of course, if the visiting team starts to win, points will be deducted from players who chose the home team to win and added to those who chose the visiting team to win. As the game progresses, players gain and lose points depending on the relative score of the team they have chosen to be the winner. Player scores are continually updated in a similar manner for each category (step S-162). Each time player scores are updated, player rankings are updated placing the player with the most points in first place with players with fewer points being ranked in decreasing order depending on their score (step S-164). This dynamic updating of scores and rankings as the game progresses heightens excitement for the players.

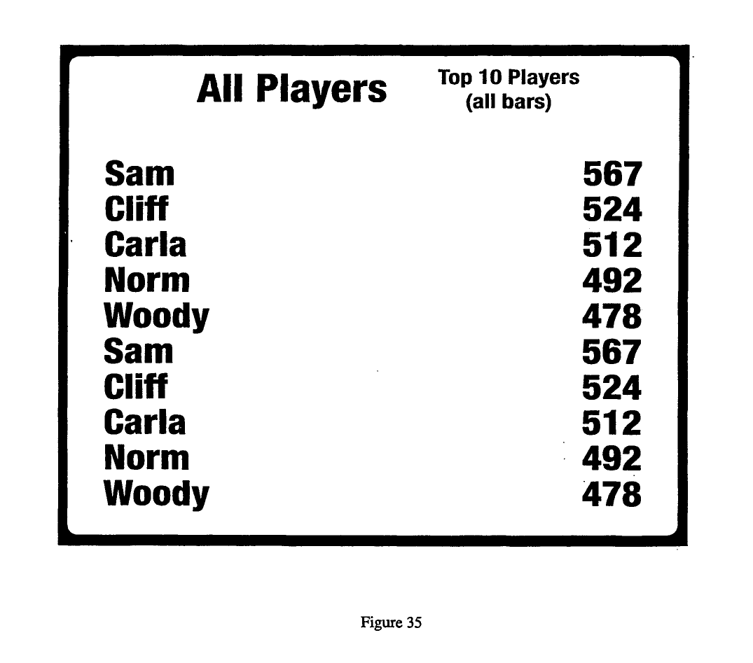

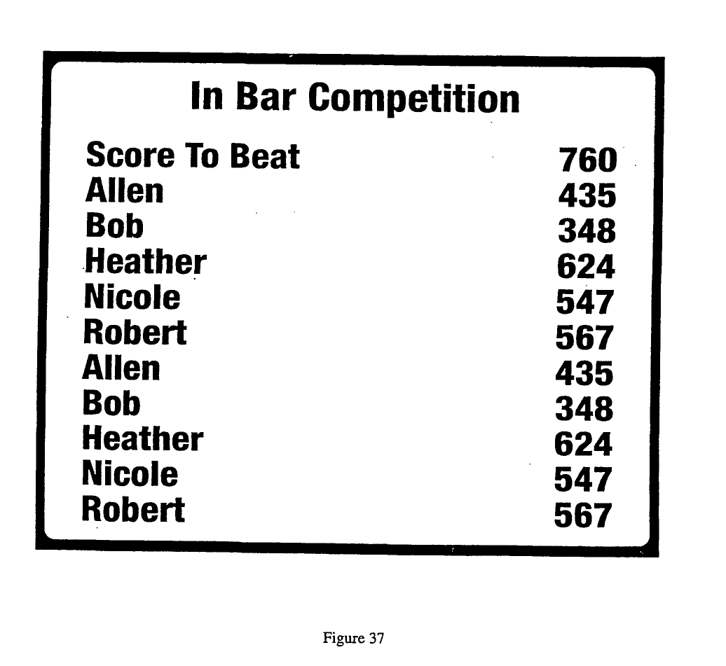

After player scores and rankings are computed, they are displayed on the touch screen 214 on the kiosk 200 and are broadcast to Internet players (step S-166; see for example FIGS. 35, 36, and 37). Internet players who did not redeem the game pack when enrolling in the game are not provided with player scores or rankings until the sporting event ends. Telephone players have an advantage over non-paying Internet players in that they may view player scores and rankings on the kiosk monitor 218 or the television monitors 216 in the participating establishment. Scores and rankings are continually updated until there is a pause in the game (step S-168). If there is a pause, for example a time out, and the game is not over, then player scores and rankings are displayed on the kiosk monitor 218 and television monitors 216 in the establishment where the kiosk 200 is located (step S-172). Sample rankings are shown in FIGS. 35, 36, and 37. Advertising may also be shown at this time.

When the sporting event ends, player scores are computed and a winner is determined (step S-174). Winners and rankings are then displayed on the television monitors 216 in the establishment, on the kiosk monitor 218 and are broadcast to all Internet players, including those who did not redeem a game pack (step S-176).

At the end of the game, the players with the most points are eligible to win promotional prizes. Prizes are not awarded from the revenue generated by players paying for time or paying for the game packs. To do so would bring the game into conflict with applicable gaming legislation. Instead, third party sponsors provide prizes. Sponsors may include the establishment where the kiosks 200 are located, promotional partners, or any other company wishing to target viewers of a given sporting event.

Prizes that may be awarded include: cash; merchandise such as baseball caps, T-shirts or tickets to a related event such as a hockey game; specialty prizes such as autographed merchandise, “player for a day” with a professional sports team, travel to a road game of a professional sports team; promotional coupons or “dollars” dispensed from the kiosk 200 and redeemable at a participating establishment; and a fixed or variable amount of kiosk time. If a variable amount of kiosk time is awarded, then the actual amount of time awarded may be calculated based on the duration of the winning player's initial registration: players who take a longer time to register, if they become winners, will be awarded more free time than players who take a shorter time to register. This may encourage players to purchase more time when initially registering for a game.

At least three variables may be used to determine how prizes are awarded. First, the individual player's score may be used. This is the player's final score following a game. The highest individual score or the lowest individual score may be used to determine a winner. If a player enters the same game more than once, making the same choices for each entry, and if the player wins for these multiple entries, then that player is awarded just one prize.

A second variable that may be used to award prizes is the average score of all players or a sub-group of players. For example, the average scores of players within a city or other defined geographical area may be used. A third variable is the average score of players at a participating establishment. Players who access the game via the IVR system or the Internet are considered members of two discrete virtual establishments. All of the above averages are calculated by totaling the scores from all entries for the defined group and dividing that sum by the number of entries.

The variables described above may be used to determine a winner as follows. The participating establishment having the highest average score for players at that establishment is awarded a set prize, such as 500 dollars cash. The cash prize is then distributed to the player with the highest individual score. If more than one player at the establishment has the same top score, then the cash prize is shared equally by all players having a top score. Players at participating establishments that do not have the highest average score win lesser prizes. For example, the player with the highest individual score in each non-winning participating establishment may win a lesser prize such as 20 dollars worth of coupons or promotional dollars, issued by the kiosk 200. Because this is a lesser prize, if there is a tie, each player still receives the 20 dollars worth of coupons or promotional dollars. The prize is not divided.

Prizes may also be awarded based on a player's previous performance. For example, players who have played at least one game previously qualify for an “all player” competition. This encourages players to continue playing after their first game, which is free. In the all player competition, the player with the highest individual score wins. If there is a tie, then the player with the highest score in the previous game wins. In the event that the previous game scores are also the same, then players with the top scores share the prize equally. Winners in the all players competition are also eligible to win additional prizes if they have the top score at the participating establishment where they entered the game, as described above.

The greater the number of players in a game, the less chance there is of winning. To encourage enrollment in the game, players who exceed a predetermined threshold, such as the average score of the all player competition, may participate in a “top player” competition the next time they play the game. Since only those who exceed a predetermined threshold may participate, the top player competition has fewer players but a relatively larger prize. Several rounds of the top player game may be implemented, wherein players who consistently exceed the threshold may enter subsequent rounds. The number of players in subsequent rounds is therefore significantly reduced thus increasing the odds of wining. Prizes may also be increased with each round to further encourage participation. Ties are resolved using the tied players' scores from the previous game. The tied player with the highest score in the previous game wins the entire prize in the present game.

Other methods of determining winners may also be applied to the game. For instance, promotion prizing may be provided in addition to one or more of the prizing structures described above. For example, the player with the highest cumulative individual score over a set number of games may be awarded a prize. Alternatively, at the end of a game the kiosk 200 may display a number between zero and nine. All players with an individual score that ends with the displayed number win a prize. Any of a multitude of other combinations and permutations of scores, calculated over one or more games, may be applied to award extra prizes and to encourage increased game enrolment.

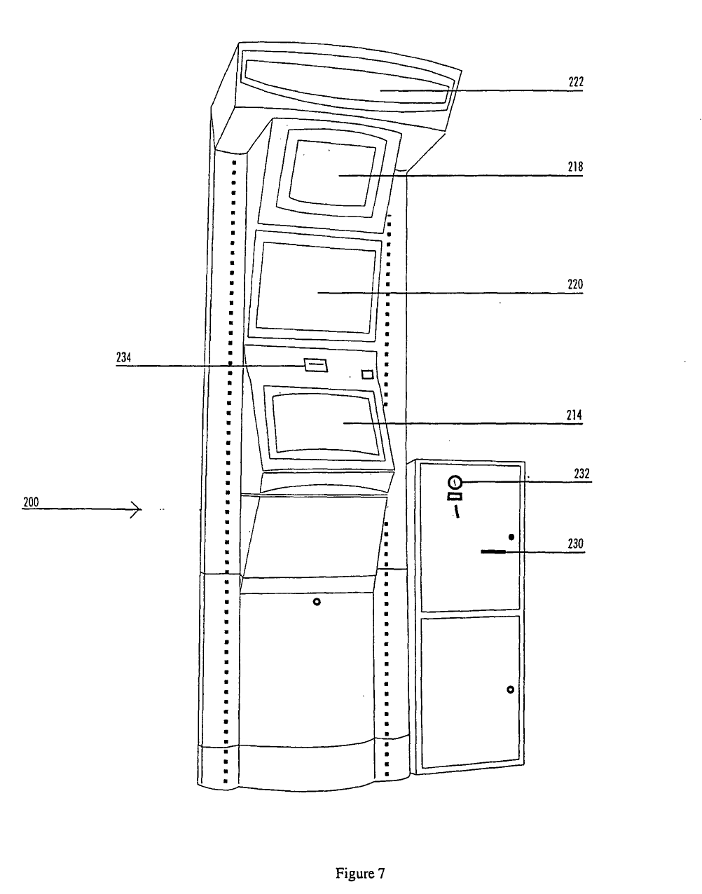

Another advantage of the preferred embodiment is that the registration information obtained provides certain demographic information about each player. Subject to privacy legislation, this information may be provided to the third party sponsors to help them determine which promotional prizes should be offered. The demographic information may also be used to sell advertising to sponsors, promotional partners and advertisers, who would like to reach a targeted audience within a defined demographic group, such as those who are enthusiasts of televised sporting events. As shown in FIG. 7, advertising may be applied to the following aspects of the game: it may be placed on the exterior surface 220 of the interactive kiosk 200; it may be broadcast while a player makes selections over the telephone 202 (for example, advertisers may each sponsor a different pick category in step S-102); advertising may be printed on the game receipts 284 in step S-41; advertising may be included in banners on the web page during Internet enrollment; it may be broadcast on the establishment's television monitors 216 during the pauses in play in step S-168; it may be displayed on a pixel board 222 positioned horizontally along the top front surface of the kiosk 200; and it may be displayed on the kiosk monitor 218.

Various levels of competition and ranking may be created by organizing players into two or more groups or “player universes”. Player universes may be mutually exclusive or they may overlap. For example, a player universe may include all players regardless of means of entry. A sample ranking of all players is provided in FIG. 35. Alternatively, or in addition, there may be a player universe which includes all players that have entered the game using a kiosk. Similarly, a player universe could include only IVR players or only Internet players. Any of these player universes could be further sub-divided by commercial establishment, city, region, state, university, age or any other grouping. The game administrator may also create a custom player universe including all players agreeing to participate in a private grouping regardless of means of entry. Prizes are awarded to players with the highest score in each player universe. If a player is a member of more than one universe they may win a prize for each such universe in which they have the highest score. Thus the number of player universes determines the number of winners.

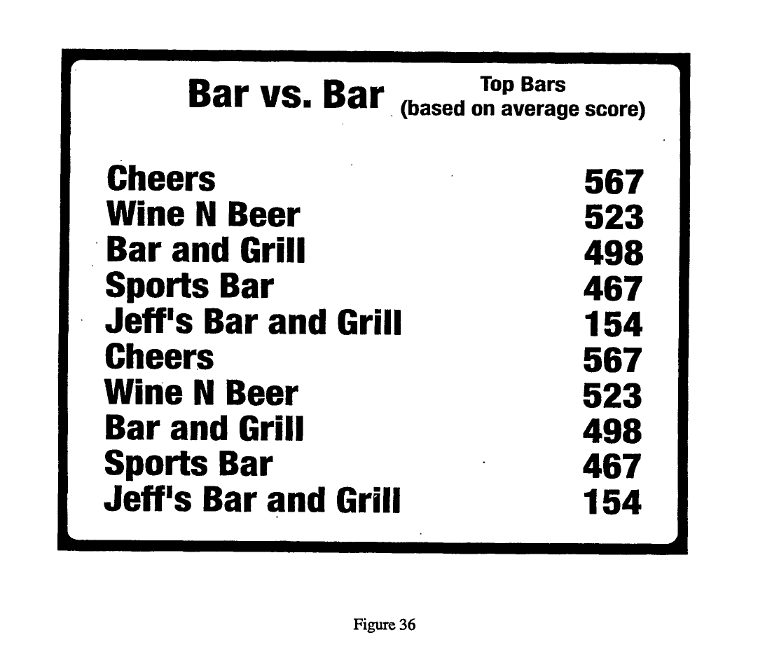

The grouping of players into player universes facilitates local competitions within each commercial establishment with a kiosk 200 or within a chain of establishments. A sample ranking of commercial establishment rankings is provided in FIG. 36. In the commercial establishment level competitions, a predetermined number of winners (e.g., first, second and third highest scores) receive prizes dispensed by the staff of the commercial establishment. Promotional prizes are awarded to the winning contestants by the game administrator or does the establishment do it? To comply with gaming legislation, the awarding of prizes requires the recipient to first answer a skill-testing question.

As highlighted above, the preferred embodiment has the advantage that it is structured to comply with gaming legislation of many jurisdictions. The present description focuses on aspects of the game that comply with the gaming legislation of Ontario, Canada when the game is played using a kiosk. The game is structured so that it may be easily re-configured to comply with the legislative requirements of other jurisdictions such as the United States.

Legislation relating to promotional games generally dictates that the following four criteria be satisfied:

1. contestants must be able to enroll in the game free of charge;

2. both paying and non-paying players must be given equal consideration;

3. the game must be structured as a game of mixed skill and chance; and

4. prizes may not be derived from game revenue.

The preferred embodiment satisfies these criteria. Players may enroll in the game free of charge when they initially register using the kiosk 200, when they enroll using a telephone 202, or when enrollment is done via the Internet 204 and a game pack is not redeemed. The second criterion is satisfied by all players, paying and non-paying, being provided with access to the game, as described for the first criterion. Furthermore, all players are provided with the opportunity to win the same prizes, regardless of whether they are paying or non-paying players. The third criterion is satisfied because the game requires a degree of skill to play. The fact that the statistical information provided to paying players tends to improve scores indicates that the game requires skill to win. Winners are also required to answer a mathematical skill testing question in order to obtain a prize. Prizes are provided by third party sponsors, which satisfies the fourth criterion. Prizes are not purchased using the revenue generated by the game.

In an alternative embodiment of the game, the game may be configured to cover several games instead of a single event. In this configuration, selections made for each category apply to a series of games, and prizes are awarded at the end of the series. Interim prizes may alternatively be awarded after each game, with a grand prize awarded to the player accruing the greatest number of points at the end of the series. For example, players may pick the winning teams for a series of consecutive games. For each consecutive game that a player correctly predicts the outcome, a prize is awarded. If the winner of every game is correctly chosen, then a grand prize is awarded.

In an alternative embodiment of the game, players may create fictional teams assembled from a list of real players. The objective is for the fictional team to score more points than other players' teams.

It will be understood by those skilled in the art that this description is made with reference to the preferred embodiments and that it is possible to make other embodiments employing the principles of the invention which fall within its spirit and scope as defined by the following claims.

I claim:

1. A method of playing a multi-player interactive game in conjunction with a single event, the single event having a plurality of sub-events, and the sub-events having a plurality of potential outcomes, comprising the steps of:
prior to the event, assigning to each of a plurality of predetermined categories, potential quantitative outcomes for sub-events;
prior to the event, assigning numeric weights to each of the potential outcomes, the weights being used to calculate scores;
prior to the event, receiving from at least one player, selections of potential outcomes which attempt to predict actual outcomes for sub-events;
during the event, calculating the score for the player by assigning points for each of the player's predicted outcomes that match actual outcomes, the points corresponding to the numeric weights assigned to each of the predicted outcomes;
regularly updating the scores during the event;
displaying the updated scores during the event; and
once the event finishes, calculating the score for each player.

2. The method of claim 1, further comprising the step of, prior to receiving selections from a player, providing the player with an option to obtain statistical information to assist the player in selecting potential outcomes for each category.

3. The method of claim 2, further comprising the step of charging the player a fee to view the statistical information if the player elects to obtain the statistical information.

4. The method of claim 1, wherein the one or more players are located in locations remote from on another; the method further comprising means for receiving at a central location player selections from the remote locations and displaying the scores for players located in different locations at the remote locations.

5. The method of claim 1, wherein one or more players are located in locations remote from one another, the player selections are received from the remote locations at a central location, and only the scores for players located in the same remote location are displayed at that remote location.

6. The method of claim 1, comprising the additional step of:
during the event, receiving player selections of potential outcomes which attempt to predict actual outcomes for sub-events for which the actual outcomes have not already occurred.

7. The method of claim 1 or 2, wherein the method is implemented in computer software on a computer readable medium.

8. The method of claim 7, wherein the software is for use on compatible hardware.

9. A system for playing a multi-player interactive game in conjunction with a single event, the single event having a plurality of sub-events, and the sub-events having a plurality of potential outcomes, comprising:
means for assigning to each of a plurality of predetermined categories, potential quantitative outcomes for sub-events;
means for assigning numeric weights to each of the potential outcomes, the weights being used to calculate scores;
means for receiving from at least one player, selections of potential outcomes which attempt to predict actual outcomes for sub-events;
means for calculating the score for the player by assigning points for each of the player's predicted outcomes that match actual outcomes, the points corresponding to the numeric weights assigned to each of the predicted outcomes;
means for regularly updating the scores during the event;
means for displaying the updated scores during the event; and
means for calculating the score for each player.

10. The system of claim 9, further comprising means for providing the player with an option to obtain statistical information to assist the player in selecting potential outcomes for each category.

11. The system of claim 10, further comprising means for charging the player a fee to view the statistical information if the player elects to obtain the statistical information.

12. The system of claim 9, wherein the one or more players are located in locations remote from on another; the system further comprising means for receiving at a central location player selections from the remote locations and means for displaying at the remote locations the scores for players located in different locations.

13. The system of claim 9, wherein one or more players are located in locations remote from one another; the system further comprising means for receiving at a central location player selections from the remote locations, and means for displaying only the scores for players located in the same remote location at that same remote location.

14. The system of claim 9, further comprising means for receiving player selections of potential outcomes which attempt to predict actual outcomes for sub-events for which the actual outcomes have not already occurred.

15. The system of claim 9, wherein the system is implemented in computer software on a computer readable medium.

16. The system of claim 10, wherein the system is implemented in computer software on a computer readable medium.

17. The system of claim 15, wherein the software is for use on compatible hardware.

18. The system of claim 16, wherein the software is for use on compatible hardware.
